(19) United States
(12) Patent Application Publication
(10) Pub. No.: US 2025/0344223 A1
(43) Pub. Date: Nov. 6, 2025

(54) CHANNEL ACCESS SELECTION FOR PHYSICAL SIDELINK FEEDBACK CHANNEL (PSFCH) COMMUNICATIONS IN UNLICENSED BANDS

(71) Applicant: QUALCOMM Incorporated, San Diego, CA (US)

(72) Inventors: Shaozhen GUO, Beijing (CN); Changlong XU, Beijing (CN); Chih-Hao LIU, San Diego, CA (US); Jing SUN, San Diego, CA (US); Xiaoxia ZHANG, San Diego, CA (US); Luanxia YANG, Beijing (CN); Siyi CHEN, Beijing (CN); Hao XU, Beijing (CN)

(21) Appl. No.: 18/862,597

(22) PCT Filed: Jun. 30, 2022
(86) PCT No.: PCT/CN2022/102647

§ 371 Date: Nov. 4, 2024

(51) Int. Cl. H04W 72/25; H04W 74/00; H04W 74/0808

(52) U.S. Cl. CPC H04W 72/25; H04W 74/004; H04W 74/006; H04W 74/0808

(57) ABSTRACT

A method of wireless communication performed in a shared frequency band at a user equipment (UE) comprises: receiving a sidelink (SL) communication; selecting a channel access configuration for a physical sidelink feedback channel (PSFCH) occasion in a shared frequency band; and transmitting, based on the channel access configuration and the SL communication, a PSFCH communication in the PSFCH occasion in the shared frequency band.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. Sidelink was introduced in LTE to allow a UE to send data to another UE without tunneling through the BS and/or an associated core network. The LTE sidelink technology had been extended to provision for device-to-device (D2D) communications, vehicle-to-everything (V2X) communications, and/or cellular vehicle-to-everything (C-V2X) communications. Similarly, NR may be extended to support sidelink communications for D2D, V2X, and/or C-V2X over a dedicated spectrum, a licensed spectrum, and/or an unlicensed spectrum.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to aspects of the present disclosure, a user equipment (UE) may select a channel access configuration for a physical sidelink feedback channel (PSFCH) communication in a shared frequency band. The channel access configuration may correspond to a channel access type, such as type 1 channel access, type 2A channel access, type 2B channel access, or type 2C channel access. In some aspects, the UE may select the channel access configuration based on an indication of channel occupancy time (COT) sharing, or an indication that an acquired COT is unavailable for sharing. In other aspects, the UE may be configured to choose a channel access configuration based on a PSFCH configuration. For example, in some aspects, the UE may select a channel access configuration that does not include sensing based on the PSFCH configuration satisfying one or more criteria for short control signaling. In another aspect, the UE may select the channel access configuration based on a channel access type indication provided by another UE. In some aspects, the UE may receive multiple indications of conflicting channel access types or configurations. In some aspects, the UE may be configured with one or more rules for selecting a channel access configuration in response to receiving the conflicting indications. Further aspects of the present disclosure describe selecting or determining channel access parameters based on one or more sidelink (SL) communications received from one or more other UEs.

According to one aspect of the present disclosure, a method of wireless communication performed in a shared frequency band at a user equipment (UE) comprises: receiving a sidelink (SL) communication; selecting a channel access configuration for a physical sidelink feedback channel (PSFCH) occasion in a shared frequency band; and transmitting, based on the channel access configuration and the SL communication, a PSFCH communication in the PSFCH occasion in the shared frequency band.

According to another aspect of the present disclosure, a user equipment (UE) comprises: a memory device; a transceiver; and a processor in communication with the memory device and the transceiver, wherein the UE is configured to: receive a sidelink (SL) communication; select a channel access configuration for a physical sidelink feedback channel (PSFCH) occasion in a shared frequency band; and transmit, based on the channel access configuration and the SL communication, a PSFCH communication in the PSFCH occasion in the shared frequency band.

According to another aspect of the present disclosure, a non-transitory, computer-readable medium comprises program code recorded thereon, wherein the program code comprises instructions executable by a processor of a user equipment (UE) to cause the UE to: receive a sidelink (SL) communication; select a channel access configuration for a physical sidelink feedback channel (PSFCH) occasion in a shared frequency band; and transmit, based on the channel access configuration and the SL communication, a PSFCH communication in the PSFCH occasion in the shared frequency band.

According to another aspect of the present disclosure, a user equipment (UE) comprises: means for receiving a sidelink (SL) communication; means for selecting a channel access configuration for a physical sidelink feedback channel (PSFCH) occasion in a shared frequency band; and means for transmitting, based on the channel access configuration and the SL communication, a PSFCH communication in the PSFCH occasion in the shared frequency band.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a wireless communication network that provisions for sidelink communications according to some aspects of the present disclosure.

FIG. 3 illustrates a sidelink communication scheme in a wireless communication network according to some aspects of the present disclosure.

FIG. 4 is a timing diagram illustrating a sidelink communication scenario, according to some aspects of the present disclosure.

FIG. 5 is a timing diagram illustrating a scheme for transmitting physical sidelink feedback channel (PSFCH) in a shared frequency band, according to aspects of the present disclosure.

FIG. 6 is a signaling diagram illustrating a method for selecting a channel access configuration for PSFCH communications in a shared frequency band, according to aspects of the present disclosure.

FIG. 7A is a diagram illustrating a scheme for communicating a PSFCH communication, according to aspects of the present disclosure.

FIG. 7B is a diagram illustrating a scheme for communicating a PSFCH communication, according to aspects of the present disclosure.

FIG. 7C is a diagram illustrating a scheme for communicating a PSFCH communication, according to aspects of the present disclosure.

FIG. 8A is a diagram illustrating a PSFCH configuration, according to aspects of the present disclosure.

FIG. 8B is a diagram illustrating a PSFCH configuration, according to aspects of the present disclosure.

FIG. 8C is a diagram illustrating a PSFCH configuration, according to aspects of the present disclosure.

FIG. 9 is a signaling diagram illustrating a method for selecting a channel access configuration for PSFCH communications in a shared frequency band, according to aspects of the present disclosure.

FIG. 10 is a block diagram of a user equipment (UE) according to some aspects of the present disclosure.

FIG. 11 is a block diagram of an exemplary base station (BS) according to some aspects of the present disclosure.

FIG. 12 is a flow diagram of a sidelink communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various aspect, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Sidelink communications refers to the communications among user equipment devices (UEs) without tunneling through a base station (BS) and/or a core network. Sidelink communication can be communicated over a physical sidelink control channel (PSCCH) and a physical sidelink shared channel (PSSCH). The PSCCH and PSSCH are analogous to a physical downlink control channel (PDCCH) and a physical downlink shared channel (PDSCH) in downlink (DL) communication between a BS and a UE. For instance, the PSCCH may carry sidelink control information (SCI) and the PSSCH may carry sidelink data (e.g., user data). Each PSCCH is associated with a corresponding PSSCH, where SCI in a PSCCH may carry reservation and/or scheduling information for sidelink data transmission in the associated PSSCH. Use cases for sidelink communication may include vehicle-to-everything (V2X), industrial IoT (IIoT), and/or NR-lite.

UEs communicating using a sidelink interface may be configured to respond to sidelink communications from other UEs with hybrid automatic repeat request (HARQ) feedback indicating whether one or more sidelink transport blocks (TBs) were successfully received or not. In some aspects, the UEs may be configured with sidelink feedback resources mapped to one or more SL data resources. For example, the UEs may be configured with physical sidelink feedback channel (PSFCH) resources. The PSFCH resources may include one or more periodic PSFCH instances. Each PSFCH instance may be associated with a PSFCH period including one or more slots. In some aspect, the UEs may communicate at least one PSSCH communication in each slot. Further, the UEs may be configured to communicate using shared or unlicensed frequency resources. These communications may be referred to as sidelink-unlicensed (SL-U). To communicate in the shared or unlicensed frequency resources, one or more UEs may perform a clear channel assessment (CCA) or channel access procedure based on a channel access type or configuration. For example, a UE may perform a listen-before-talk (LBT) procedure by obtaining channel measurements for a fixed or variable amount of time. If the channel measurements are below a configured threshold, the UE may initiate or acquire a channel occupancy time (COT) to communicate with one or more other UEs. In some aspects, communications from one UE to another specific UE may be referred to as unicast communications. Communications from one or more UEs to one or more other UEs may be referred to as groupcast or multicast communications.

In some aspects, a UE initiating or acquiring a COT may share at least a portion of the COT with another UE. For example a first UE may perform a channel access procedure to acquire a COT, transmit a SL communication to a second UE in a first portion of the COT, and receive a SL communication from the second UE in a second shared portion of the COT. In some aspects, the first UE may indicate COT sharing information (COT-SI) in the first SL communication. In some aspects, the second UE may transmit a PSFCH communicating indicating feedback information associated with the first SL communication in a shared portion of the COT. For example, the feedback information may indicate one or more acknowledgements or non-acknowledgements (ACK/NACK) for one or more corresponding PSSCH communications. In some circumstances, the second UE may have scheduled a PSFCH communication where no COT sharing indication has been received. Accordingly, in some instances, the second UE may perform a channel access procedure to obtain a COT and transmit the PSFCH communication in the COT.

Channel access configurations vary in duration and power consumption. For example, a type 1 channel access procedure may involve or include a relatively longer channel sensing period than a type 2A or type 2B channel access procedure. It may be desirable to use a shorter channel access configuration where available while complying with channel access requirements and/or criteria. Further, a UE communicating in a sidelink (SL) network may be configured to transmit and/or receive communications from a plurality of UEs. In some aspects, a PSFCH occasion may occur during a COT acquired by a first UE, but the PSFCH communication may be scheduled for transmission to a different second UE. Further, COT sharing indications or other indications associated with channel access type or configuration for a PSFCH occasion may conflict.

The present disclosure provides systems, schemes, and mechanisms for selecting and performing channel access procedures for PSFCH communications in shared frequency bands. In some aspects, a channel access configuration may correspond to a channel access type, such as type 1 channel access, type 2A channel access, type 2B channel access, or type 2C channel access. In some aspects, the UE may select the channel access configuration based on an indication of channel occupancy time (COT) sharing, or an indication that an acquired COT is unavailable for sharing. In other aspects, the UE may be configured to choose a channel access configuration based on a PSFCH configuration. For example, in some aspects, the UE may select a channel access configuration that does not include sensing based on the PSFCH configuration satisfying one or more criteria for short control signaling. In another aspect, the UE may select the channel access configuration based on a channel access type indication provided by another UE. In some aspects, the UE may receive multiple indications of conflicting channel access types or configurations. In some aspects, the UE may be configured with one or more rules for selecting a channel access configuration in response to receiving the conflicting indications. Further aspects of the present disclosure describe selecting or determining channel access parameters based on one or more sidelink (SL) communications received from one or more other UEs. In some aspects, the UE may be configured with one or more rules or hard coded configurations for selecting the channel access configurations according to the schemes, methods, and mechanisms described herein.

Aspects of the present disclosure can provide several benefits. For example, by providing a coordinated mechanism for selecting a channel access type, a UE may be able to select a channel access type that is more suitable for the scenario. For example, the UE may select a channel access type or configuration that involves a shorter sensing period, thereby decreasing delay and decreasing power consumption. Further, the methods and mechanisms described herein may allow for fewer channel access procedures to be performed and to utilize COTs more efficiently. Further, by facilitating more continuous sidelink communications in the shared frequency resources, the chance of collisions and/or interference may decrease. Thus, the error rate may also decrease, which can increase network speeds and reduce overhead, leading to an improved user experience. While the present disclosure is described in the context of deploying autonomous sidelink communication over a 2.4 GHz unlicensed band, the disclosed aspect can be applied to any suitable shared or unlicensed band.

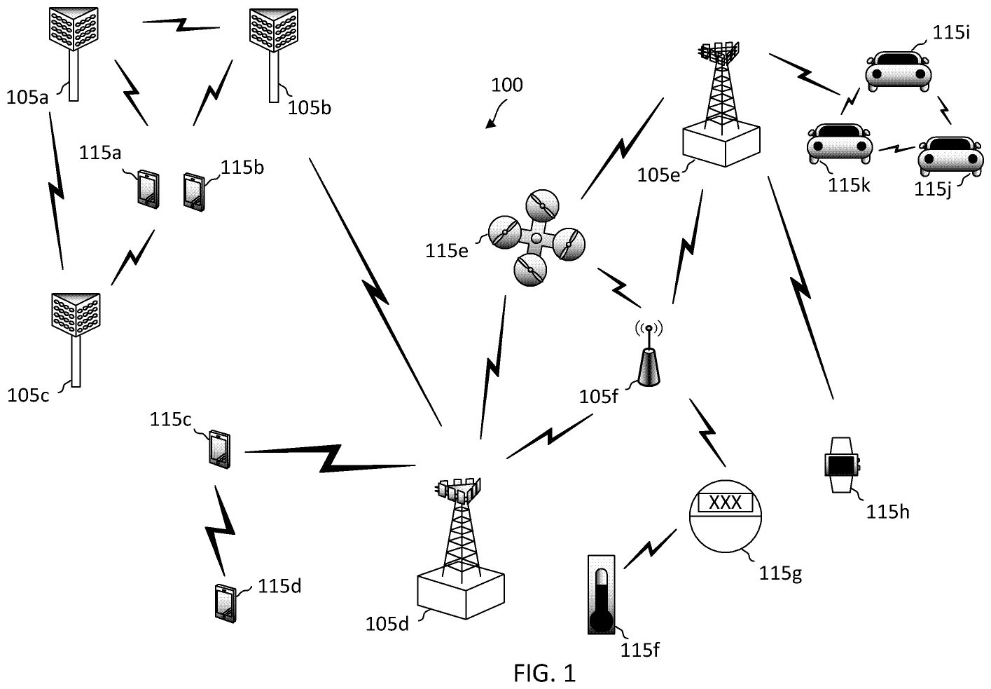

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. In some aspects, a CAT1 LBT may be referred to as type 2C channel access. A CAT2 LBT refers to an LBT without a random backoff period. For instance, a transmitting node may determine a channel measurement in a time interval and determine whether the channel is available or not based on a comparison of the channel measurement against a ED threshold. In some aspects, a CAT2 LBT may be referred to as type 2A channel access or type 2B channel access. In some aspects, whether CAT2 LBT is type 2A or type 2B may depend on a gap or idle period. The sensing period or interval for type 2A channel access may be 25 microseconds. The sensing period or interval for type 2B channel access may be 16 microseconds. A CAT4 LBT refers to an LBT with a random backoff and a variable contention window (CW). For instance, a transmitting node may draw a random number and backoff for a duration based on the drawn random number in a certain time unit. In some aspects, the CAT4 LBT may be referred to as type 1 channel access.

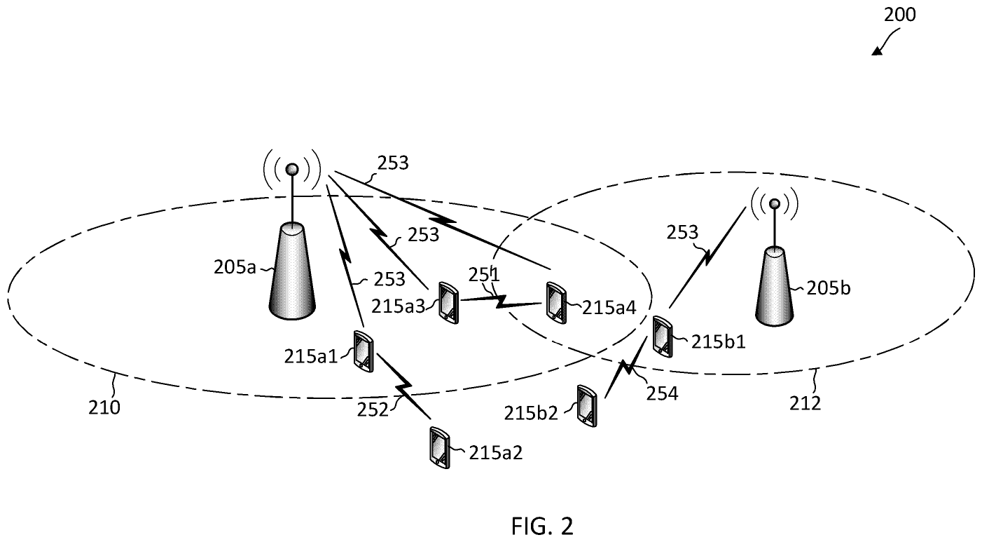

In some aspects, the network 100 may support sidelink communication among the UEs 115 over a shared radio frequency band (e.g., in a shared spectrum or an unlicensed spectrum). In some aspects, the UEs 115 may communicate with each other over a 2.4 GHz unlicensed band, which may be shared by multiple network operating entities using various radio access technologies (RATs) such as NR-U, WiFi, and/or licensed-assisted access (LAA) as shown in FIG. 2.

FIG. 2 illustrates an example of a wireless communication network 200 that provisions for sidelink communications according to aspect of the present disclosure. The network 200 may correspond to a portion of the network 100. FIG. 2 illustrates two BSs 205 (shown as 205a and 205b) and six UEs 215 (shown as 215a1, 215a2, 215a3, 215a4, 215b1, and 215b2) for purposes of simplicity of discussion, though it will be recognized that aspect of the present disclosure may scale to any suitable number of UEs 215 (e.g., the about 2, 3, 4, 5, 7 or more) and/or BSs 205 (e.g., the about 1, 3 or more). The BS 205 and the UEs 215 may be similar to the BSs 105 and the UEs 115, respectively. The BSs 205 and the UEs 215 may share the same radio frequency band for communications. In some instances, the radio frequency band may be a 2.4 GHz unlicensed band, a 5 GHz unlicensed band, or a 6 GHz unlicensed band. In general, the shared radio frequency band may be at any suitable frequency.

The BS 205a and the UEs 215a1-215a4 may be operated by a first network operating entity. The BS 205b and the UEs 215bl-215b2 may be operated by a second network operating entity. In some aspects, the first network operating entity may utilize a same RAT as the second network operating entity. For instance, the BS 205a and the UEs 215a1-215a4 of the first network operating entity and the BS 205b and the UEs 215bl-215b2 of the second network operating entity are NR-U devices. In some other aspects, the first network operating entity may utilize a different RAT than the second network operating entity. For instance, the BS 205a and the UEs 215a1-215a4 of the first network operating entity may utilize NR-U technology while the BS 205b and the UEs 215bl-215b2 of the second network operating entity may utilize WiFi or LAA technology.

In the network 200, some of the UEs 215a1-215a4 may communicate with each other in peer-to-peer communications. For example, the UE 215a1 may communicate with the UE 215a2 over a sidelink 252, the UE 215a3 may communicate with the UE 215a4 over another sidelink 251, and the UE 215b1 may communicate with the UE 215b2 over yet another sidelink 254. The sidelinks 251, 252, and 254 are unicast bidirectional links. Some of the UEs 215 may also communicate with the BS 205a or the BS 205b in a UL direction and/or a DL direction via communication links 253. For instance, the UE 215a1, 215a3, and 215a4 are within a coverage area 210 of the BS 205a, and thus may be in communication with the BS 205a. The UE 215a2 is outside the coverage area 210, and thus may not be in direct communication with the BS 205a. In some instances, the UE 215a1 may operate as a relay for the UE 215a2 to reach the BS 205a. Similarly, the UE 215b1 is within a coverage area 212 of the BS 205b, and thus may be in communication with the BS 205b and may operate as a relay for the UE 215b2 to reach the BS 205b. In some aspects, some of the UEs 215 are associated with vehicles (e.g., similar to the UEs 115i-k) and the communications over the sidelinks 251, 252, and 254 may be C-V2X communications. C-V2X communications may refer to communications between vehicles and any other wireless communication devices in a cellular network.

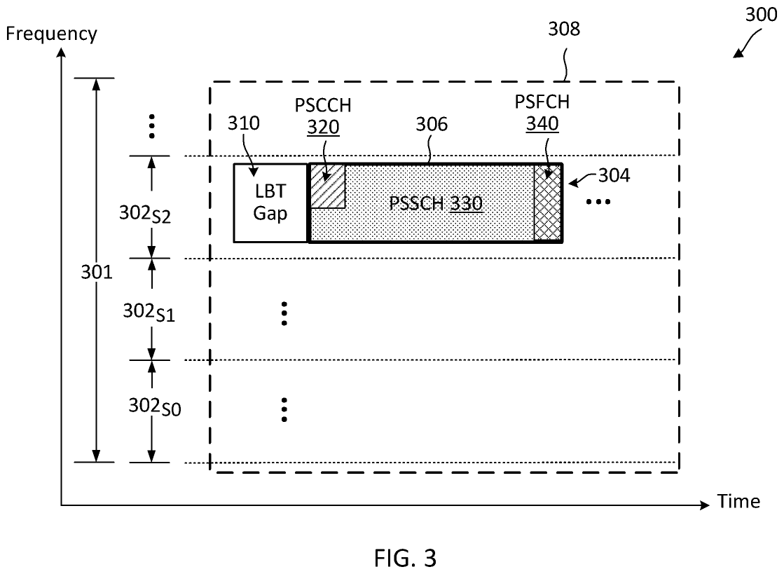

FIG. 3 illustrates a sidelink communication scheme 300 in a wireless communication network according to some aspects of the present disclosure. The scheme 300 may be employed by UEs such as the UEs 115 and/or 215 in a network such as the networks 100 and/or 200. In particular, sidelink UEs may employ the scheme 300 to contend for access in a shared radio frequency band (e.g., in a shared spectrum or an unlicensed spectrum) for sidelink communication. The shared radio frequency band may be shared by multiple RATs as discussed in FIG. 2. In FIG. 3, the x-axis represents time in some arbitrary units, and the y-axis represents frequency in some arbitrary units.

In scheme 300, a shared radio frequency band 301 is partitioned into a plurality of subchannels or frequency subbands 302 (shown as 302_{S0}, 302_{S1}, 302_{S2}, . . . ) for sidelink communication. The frequency band 301 may be at any suitable frequencies. In some instances, the frequency band 301 is a 2.4 GHz unlicensed band. In some instances, the frequency band 301 is a 5 GHz unlicensed band. In some instances, the frequency band 301 is a 6 GHz unlicensed band. The frequency band 301 may have any suitable BW and may be partitioned into any suitable number of frequency subbands 302. The number of frequency subbands 302 can be dependent on the sidelink communication BW requirement. In some aspects, the frequency band 301 is a 2.4 GHz unlicensed band and may have a bandwidth of about 80 megahertz (MHz) partitioned into about fifteen 5 MHz frequency subbands 302.

A sidelink UE (e.g., the UEs 115 and/or 215) may be equipped with a wideband receiver and a narrowband transmitter. For instance, the UE may utilize the narrowband transmitter to access a frequency subband 302_{S2} for sidelink transmission utilizing a frame structure 304. The frame structure 304 is repeated in each frequency subband 302. In some instances, there can be a frequency gap or guard band between adjacent frequency subbands 302 as shown in FIG. 3, for example, to mitigate adjacent band interference. Thus, multiple sidelink data may be communicated simultaneously in different frequency subbands 302 (e.g., FDM). The frame structure 304 is also repeated in time. For instance, the frequency subband 302_{S2} may be time-partitioned into a plurality of frames with the frame structure 304. The frame structure 304 includes an LBT gap duration 310 followed by a sidelink resource 306. The LBT gap duration 310 is used for channel contention among devices of the same RAT or among devices of different RATs. Upon winning contention, the sidelink UE may utilize the sidelink resource 306 for transmission of control and user data.

The sidelink resource 306 may have a substantially similar structure as an NR sidelink resource. For instance, the sidelink resource 306 may include a number of subcarriers or RBs in frequency and a number of symbols in time. In some instances, the sidelink resource 306 may have a duration between about one millisecond (ms) to about 20 ms. The sidelink resource 306 may include a PSCCH 320, a PSSCH 330, and/or a physical sidelink feedback channel (PSFCH) 340. The PSCCH 320, the PSSCH 330, and the PSFCH 340 can be multiplexed in time and/or frequency. In the illustrated example of FIG. 3, the PSCCH 320 is located during the beginning symbol(s) (e.g., about 1 symbol or about 2 symbols) of the sidelink resource 306 and occupies a portion of the frequency subband 302_{S2}. The PSFCH 340 is located at the ending symbol(s) of the sidelink resource 306. The PSSCH 330 occupies the remaining time-frequency resources in the sidelink resource 306. In general, the PSCCH 320, the PSSCH 330, and the PSFCH 340 may be multiplexed in any suitable configuration within the sidelink resource 306.

A sidelink UE (e.g., the UEs 115 and/or 215) intending to transmit in the frequency band 301 may perform a narrowband LBT in one or more frequency subbands 302. As an example, the sidelink UE may perform an LBT in the frequency subbands 302_{S2} during the LBT gap duration 310. The LBT may be an energy detection-based CAT4 LBT as discussed above with reference to FIG. 1. If the LBT is a pass (e.g., when the measured channel signal energy is below an energy detection threshold), the sidelink UE may proceed to transmit SCI and sidelink data to a peer sidelink UE in the sidelink resource 306. If the LBT fails (e.g., when the channel signal energy is above the energy detection threshold), the sidelink UE may refrain from transmitting in the sidelink resource 306. As such, the LBT can operate to gate access or occupancy in a frequency subband 302_{S2} and to facilitate coexistence with other technologies sharing the frequency band 301.

The sidelink UE may transmit the SCI in the PSCCH 320 and the sidelink data (e.g., user information data) in the PSSCH 330. The sidelink data can be of various forms and types depending on the sidelink application. For instance, when the sidelink application is a V2X application, the sidelink data may carry V2X data (e.g., vehicle location information, traveling speed and/or direction, vehicle sensing measurements, etc.). Alternatively, when the sidelink application is an IIoT application, the sidelink data may carry IIoT data (e.g., sensor measurements, device measurements, temperature readings, etc.). The sidelink UE may also transmit a HARQ ACK/NACK in the PSFCH 340. The HARQ ACK/NACK may be a feedback for sidelink data received by the sidelink UE in an earlier sidelink resource 306. The SCI can indicate a reservation for a next sidelink resource 306. Thus, an intra-NR sidelink UE (e.g., a UE in the same NR-U sidelink system) may perform SCI sensing to determine whether a sidelink resource 306 is available or occupied for intra-NR sharing. For instance, if the intra-NR sidelink UE detected SCI indicating a reservation for the sidelink resource 306, the intra-NR sidelink UE may refrain from transmitting in the reserved sidelink resource 306. If the intra-NR sidelink UE determines that there is no reservation detected for a sidelink resource 306, the intra-NR sidelink UE may transmit in the sidelink resource 306. As such, SCI sensing can assist a UE in identifying a target frequency subband 302 to reserve for sidelink communication and to avoid collision (e.g., intra-NR collision) with another sidelink UE in the NR sidelink system. In some aspects, the intra-RAT sidelink UE may be configured with a sensing window for SCI sensing or monitoring to reduce intra-NR collision.

The SCI can also indicate scheduling information and/or a destination identifier (ID) identifying a target receiving sidelink UE for the next sidelink resource 306. Thus, a sidelink UE may monitor SCIs transmitted by other sideling UEs. Upon detecting SCI in a sidelink resource 306, the sidelink UE may determine whether the sidelink UE is the target receiver based on the destination ID. If the sidelink UE is the target receiver, the sidelink UE may proceed to receive and decode the sidelink data indicated by the SCI.

In some aspects, the scheme 300 is used for synchronous sidelink communication. In other words, the sidelink UEs are synchronized in time and are aligned in terms of symbol boundary, sidelink resource boundary (e.g., the starting time of sidelink resource 306), LBT gap duration boundary (e.g., the starting time of the LBT gap duration 310). The sidelink UEs may perform synchronization in a variety of forms, for example, based on sidelink SSBs received from a sidelink UE and/or NR-U SSBs received from a BS (e.g., the BSs 105 and/or 205) while in-coverage of the BS. In some aspects, a sidelink UE in the system may be preconfigured with a resource pool 308 in the frequency band 301, for example, while in a coverage of a serving BS. The resource pool 308 may include a plurality of sidelink resources 306 arranged as shown in the frame structure 304. The BS can configure the sidelink UE with a resource pool configuration indicating resources in the frequency band 301 and/or the subbands 302, the frame structure 304 (e.g., the LBT gap duration 310 and/or the sidelink resource 306), and/or timing information (e.g., LBT gap duration 310 start and end boundaries).

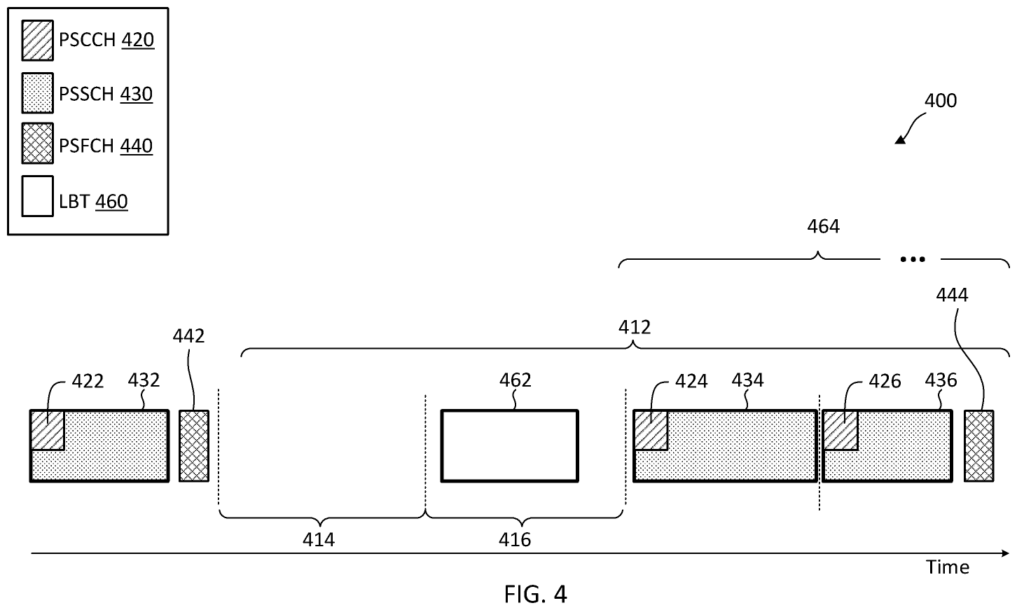

FIG. 4 illustrates a sidelink communication scenario 400 in a shared frequency band, according to aspects of the present disclosure. The scenario 400 may involve UEs such as the UEs 115 and/or 215 in a network such as the networks 100 and/or 200. In particular, sidelink UEs may communicate and/or operate according to the scenario 400 to contend for access in a shared radio frequency band (e.g., in a shared spectrum or an unlicensed spectrum) for sidelink communication. The shared radio frequency band may be shared by multiple RATs as discussed in FIG. 2. In FIG. 4, the x-axis represents time in some arbitrary units, and the y-axis represents frequency in some arbitrary units.

In the scenario 400, a UE may communicate using a plurality of sidelink resources, as similarly discussed above with respect to the scheme 300. The sidelink resources may include PSCCHs 420, PSSCHs 430, and PSFCHs 440. The scenario 400 includes sidelink communications in the shared frequency band over a period of time including a plurality of slots (e.g., 414, 416). The time domain configuration of the scenario 400 may include periodic and/or semi-persistent PSFCH resources 440 including PSFCH instances 442, 444. The PSFCH resources 440 may be a global or common configuration for a plurality of UEs communicating in a cell and/or network, in some aspects. The PSFCH resources 440 may be used to transmit SL feedback information and/or to receive SL feedback information. In some aspects, SL feedback information may include hybrid automatic repeat request (HARQ) acknowledgement/non-acknowledgement (ACK/NACK) for one or more PSSCH instances, such as the first PSSCH 432 and/or the second PSSCH 434. The periodicity of the PSFCH resources 440 may be referred to as a PSFCH period 412. The PSFCH period 412 may me one or more slots, such as 1, 2, 4, 6, 8 and/or any other suitable number of slots. In the illustrated example, the PSFCH period 412 is four slots. In some aspects, a UE may determine whether there is SL feedback information to receive in a PSFCH resource, or whether there is SL feedback information to transmit in a PSFCH resource.

The sidelink resources may be associated with or acquired by a LBT 460. For example, the UE may perform a LBT to acquire a channel occupancy time (COT). If the LBT results in a pass, the UE acquires a COT during which the UE communicates in the first PSCCH 422 and the first PSSCH 432. Following the first PSSCH 432, the UE may be configured with a periodic and/or semi-persistent PSFCH resource or instance 442. In some aspects, the PSFCH instance 442 may result in a link switch and/or a gap in communications during the first COT. In some aspects, the gap in communications may exceed the configured COT maintenance threshold described above. Accordingly, the UE may refrain from transmitting and/or receiving during the following slot 414. The UE may then perform a second LBT 462 during a second slot 416. Based on the second LBT 462, the UE may acquire a COT 464 during which the UE may communicate in a second PSCCH 424, a second PSSCH 434, a third PSCCH 426, and a third PSSCH 436. The UE may continue the COT 464, without performing an additional LBT, between the PSSCH 434 and the PSSCH 436 if the gap between the PSSCH 434 and the PSSCH 436 is equal to or lower than the configured COT maintenance threshold. For example, the UE may continue to communicate during the COT 464 if the gap between sidelink communications is less than 25 μs. In another example, the UE may continue to communicate during the COT 464 if the gap between sidelink communications is equal to or less than 16 μs.

The PSFCH resources 440 include a second PSFCH instance 444 following the third PSSCH 436. In some aspects, there may be a gap between the third PSSCH 436 and the second PSFCH instance 444. In some aspects, the gap may be greater than 16 μs, or greater than 25 μs. If the gap exceeds 25 μs, the UE may be indicated or configured to perform an additional LBT to continue communicating during the COT 464. In another aspect, the UE may perform an additional LBT to acquire or initiate anew COT before sidelink communications can resume. Further, in some aspects, the UE may not have PSFCH communications to transmit or to receive. However, the additional LBT would result in undesirable overhead and decreased throughput. Accordingly, the efficiency of the sidelink communications in the shared frequency band may decrease.

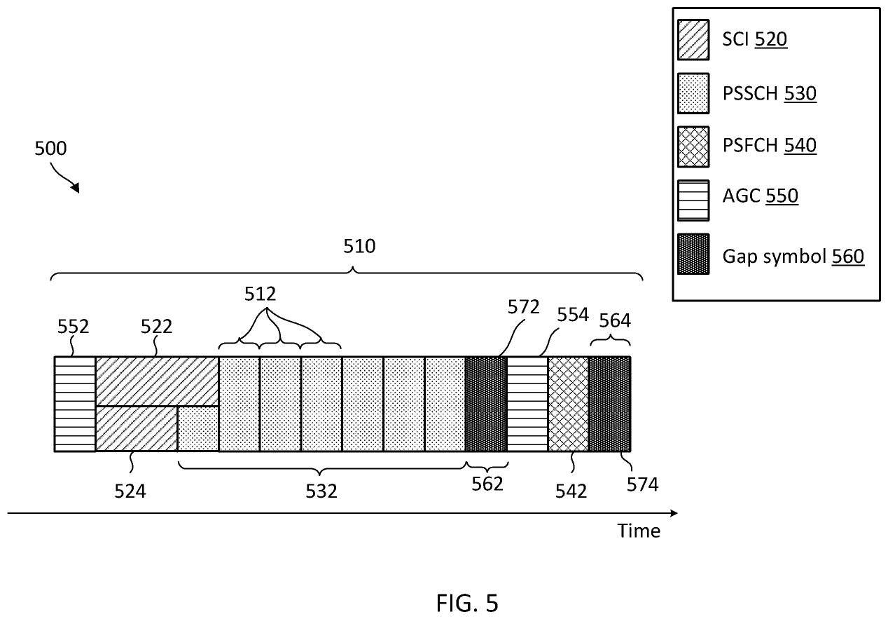

FIG. 5 is a diagram illustrating a SL communication scheme 500 for a shared frequency band. Aspects of the present disclosure may be performed by a first wireless communication device and/or a second wireless communication device. For example, in one aspect, one or more actions of the scheme 500 may be performed by a first user equipment communicating with a second user equipment. FIG. 5 shows a plurality of sidelink resources configured for sidelink communications between the first wireless communication device and the second wireless communication device the sidelink resources are distributed over a slot 510 the slot 510 includes a plurality of symbols 512. As similarly illustrated in FIG. 4, the slot 510 may be a portion of a COT obtained by performing a LBT in the shared frequency band. The communications within the slot 510 include sidelink control information (SCI) 520, PSSCH data 530, PSFCH data 540, automatic gain control symbols (AGC) 550, and gap symbols 560. For instance, the first symbol of the slot 510 includes a first AGC 552. The first AGC 552 may include or be based on a copy of the signals, waveforms, and/or data in the immediately following symbol. The SCI 520 communicated during the slot 510 includes a first SCI 522 and a second SCI 524. In some aspects, the first SCI 522 includes SCI-1. In another aspect, the second SCI 524 includes SCI-2. In some aspects, the first SCI 522 is communicated using PSCCH resources, and the second SCI 524 is communicated using PSSCH resources. The slot also includes a PSSCH communication 532. The PSSCH communication 532 may include SL data, RRC information elements (IEs), media access control (MAC) IEs and/or control elements (CEs). The SL data may be communicated in one or more transport blocks (TBs).

In some aspects, the resources for each of the SL communications may be configured for a SL resource pool. In some aspects, the SL resource pool may indicate time and/or frequency resources for each of a plurality of channels, such as the PSCCH, the PSSCH, and the PSFCH. In some aspects, the allocation of frequency resources may include one or more sets of resource blocks (RBs), one or more interlaces of RBs, one or more subchannels, and/or one or more partial RBs. In some aspects, the frequency resources may be different for different channels. For example, the SL resource pool may indicate a first subset of frequency resources for the SCI 520, a second subset of frequency resources for the PSSCH communications 530, and a third subset of frequency resources for the PSFCH communications 540. In some aspects, the SL resource pool may include or indicate a first interlace of RBs for the PSSCH communications 530, and a second interlace of RBs for the PSFCH communications 540. Further, the UEs may be configured with a mapping scheme or configuration for mapping PSSCH resources to the PSFCH resources. For example, the PSFCH resources may be divided into subsets or portions, where each subset is allocated for a PSSCH communication 530 in a given PSSCH resource and/or slot.

For PSFCH communications, a UE may be configured with a dynamic HARQ timeline, or a fixed HARQ timeline. For a dynamic HARQ timeline, the SCI in each slot may include a value of K1 indicating which PSFCH instance carries the SL feedback information for the associated PSSCH in a later slot. For example, a K1 value of 5 may indicate that the SL feedback information (e.g., ACK, NACK) for the associated PSSCH communication may be provided in a PSFCH resource 5 slots in the future. For a fixed HARQ timeline, a UE may be configured with a MinTimeGapPSFCH value, which indicates a minimum number of slots after the last slot of a PSSCH communication before the UE transmits the PSFCH.

The slot 510 includes a PSFCH instance 542. For example, the UEs may be configured with a periodic PSFCH resource that occurs once every n slots. In some aspects, n may be 1, 2, 3, 4, 5, 6, 8, and/or any other suitable number of slots. In some aspects, the value of n may be referred to as the PSFCH period, as explained above. Between the PSSCH communication 532 and the PSFCH resource 542 there is at least one gap symbol 562 and a AGC symbol 554.

In some instances, the PSFCH communication in the PSFCH instance 542 may include a SL ACK/NACK transmitted by the second wireless communication device to acknowledge reception or no reception of one or more PSSCH communications transmitted by the first wireless communication device. For example, in some aspects, the PSFCH communication may indicate SL ACK/NACK for one or more PSSCH instances preceding the PSFCH resource. In some aspects, the PSFCH communication in the PSFCH instance 542 may indicate ACK/NACK for each PSSCH communication in a PSFCH period. In some aspects, the PSFCH communication in the PSFCH instance 542 may indicate ACK/NACK for PSSCH communications over a plurality of PSFCH periods. In another aspect, the PSFCH communication in the PSFCH instance 542 may indicate ACK/NACK or other SL feedback information associated with the SCI 520. For example, the first wireless communication device may indicate the second wireless communication device to transmit SL feedback information based on decoding at least one of the first SCI 522 or the second SCI 524. Thus, if the second wireless communication device does not have PSFCH information to transmit in the PSFCH instance 542, the second wireless communication device may transmit the SL feedback information in the PSFCH instance 542 based on decoding the SCI 522, 524.

In the scheme 500, the UE may be configured to transmit both PSSCH and PSFCH in a same slot. However, it will be understood that the UE may not have PSCCH and/or PSSCH for transmission in the slot with the PSFCH occasion. Accordingly, in some aspects, the UE may transmit only the AGC symbol 554 and the PSFCH symbol 542. In some aspects, the UE may perform a channel access procedure for access to the PSFCH resources in the shared frequency band. For example, in the absence of a COT sharing indication from a UE acquiring a COT, the UE may perform a type 1 channel access procedure (CAT4 LBT) to acquire a COT and transmit a PSFCH communication in a scheduled PSFCH occasion. Channel access types may vary in duration and power consumption. For example, a type 1 channel access procedure may involve or include a relatively longer channel sensing period than a type 2A or type 2B channel access procedure. It may be desirable to use a shorter channel access configuration where available while complying with channel access requirements and/or criteria. Further, a UE communicating in a sidelink (SL) network may be configured to transmit and/or receive communications from a plurality of UEs. In some aspects, a PSFCH occasion may occur during a COT acquired by a first UE, but the PSFCH communication may be scheduled for transmission to a different second UE. Further, COT sharing indications or other indications associated with channel access type or configuration for a PSFCH occasion may conflict. The present disclosure provides systems, schemes, and mechanisms for selecting and performing channel access procedures for PSFCH communications in shared frequency bands.

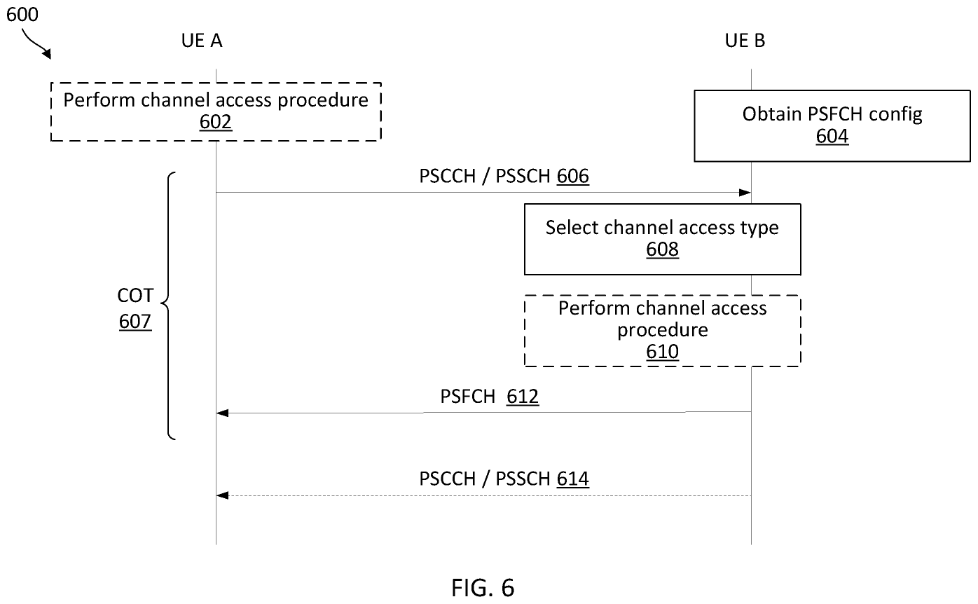

FIG. 6 is a signaling diagram of a method 600 for wireless communication performed by a first UE (UE A) and a second UE (UE B). The UEs may be UEs 115 in the network 100 and/or UEs 215 in the network 200. The method 600 may include aspects of the scheme 500 shown in FIG. 5. The method 600 may include the UEs A and B communicating via a sidelink interface in a shared frequency band. For example, the method 600 may include communicating using a sidelink-unlicensed (SL-U) protocol. In some aspects, the UEs A and B may communicate using a PC5 interface. As mentioned above, to communicate in shared or unlicensed frequency resources, one or both of the UEs A and B may perform a channel access procedure, such as a listen-before-talk (LBT), to acquire a set of time resources in a frequency band or subband. The time resources may be referred to as a channel occupancy time (COT).

For the purposes of FIG. 6, actions that are optional or alternative in the example method 600 are illustrated with dashed lines and dashed boxes. However, it will be understood that the dashed lines and boxes are not the only available options or alternatives and that one or more of the other actions of the method 600 may be removed, duplicated, substituted, switched, or otherwise modified within the scope of the present disclosure.

At action 602, UE A performs a channel access procedure. The channel access procedure may correspond to a channel access type. For example, the channel access procedure may be a type 1 channel access procedure, a type 2A channel access procedure, a type 2B channel access procedure, or a type 2C channel access procedure. Based on the channel access procedure, UE A may initiate or acquire a COT 607. In some aspects, UE B may share a portion of the COT 607 to transmit PSFCH to the UE A, as explained further below. In other aspects, UE B may not share the COT 607 from UE A. For example, UE A may indicate, to UE B, that UE A will not share the COT 607 with UE B. In some aspects, one or more PSFCH occasions configured for UE B may be within or during the COT 607.

At action 604, UE B obtains a PSFCH configuration. In some aspects, obtaining the PSFCH configuration may include receiving a signal indicating the configuration from another wireless communication device. For example, in some aspects, action 604 may include UE B receiving the PSFCH configuration from a network device or network entity. For example, UE B may receive the PSFCH configuration from a BS. In other aspect, UE B may receive the PSFCH configuration from another UE. For example, UE B may receive the PSFCH configuration from UE A, or from a different UE. In some aspects, UE B may receive a signal having an indicator. The indicator in the signal may indicate or identify one or more PSFCH parameters of configurations preconfigured at UE B. In another aspect, action 604 may include UE B retrieving the PSFCH from a memory device of UE B. For example, in some aspects, the PSFCH configuration may be hard coded at UE B. In some aspects, a plurality of PSFCH configurations are hard coded at UE B and UE B may select the PSFCH configuration based on a received signal.

The PSFCH configuration may include or indicate the time and/or frequency resources for PSFCH occasions. In some aspects, the PSFCH configuration may include or indicate at least one of a PSFCH periodicity, a total duration of PSFCH transmissions within an observation period, a number of PSFCH transmissions within an observation period, a duration of each PSFCH occasion or communication, and/or any other suitable parameter. In some aspects, the parameters stated above may be indicated for or associated with a SCS. For example, a PSFCH configuration for a SCS of 15 kHz and a PSFCH periodicity of 1 may indicate 50 PSFCH transmissions within a 50 ms observation period. The PSFCH configuration for a SCS of 30 kHz and a PSFCH periodicity of 1 may indicate 100 PSFCH transmissions within the 50 ms observation period. Tables 4 and 5 include exemplary PSFCH configurations and associated parameters as explained further below.

At action 606, UE A transmits, and UE B receives, a sidelink (SL) communication comprising at least one of a PSCCH or a PSSCH communication. In some aspects, action 606 may include UE B receiving and decoding SCI in a PSCCH and/or PSSCH, and determining a location of at least one PSSCH associated based on the SCI. In some aspects, UE B may receive the SL communication in a SL resource pool or SL resource allocation. In some aspects, the SL resource pool may include a set of time and frequency resources. The SL resource pool may be semi-statically configured, dynamically configured, statically configured, and/or any other suitable type of resource configuration. In some aspects, UE B may receive the SL communication in a shared frequency band or unlicensed frequency band. In some aspects, UE B may receive the SL communication in a COT associated with a channel access configuration. For example, UE B may receive the SL communication from UE A within a COT 607 initiated by UE A. In some aspects, the COT 607 may be initiated by UE A based on the channel access procedure performed at action 602. The channel access procedure may correspond to a channel access type. For example, the channel access procedure may be a type 1 channel access procedure, a type 2A channel access procedure, a type 2B channel access procedure, or a type 2C channel access procedure. In some aspects, UE B may share a portion of the COT to transmit PSFCH to the UE A, as explained further below. In other aspects, UE B may not share the COT.

In some aspects, UE B may receive the SL communication within or during a PSFCH period. In some aspects, the PSFCH period may include or extend for one or more slots. In this regard, UE B may be configured with a PSFCH resource configuration indicating a PSFCH periodicity. The PSFCH periodicity may indicate a quantity of slots. In some aspects, the PSFCH periodicity may be one slot, two slots, four slots, eight slots, and/or any other suitable number of slots. SL communications such as PSSCH received during a PSFCH period may be associated with a PSFCH occasion for the PSFCH period.

At action 608, UE B selects a channel access configuration for a PSFCH occasion in a shared frequency band. In some aspects, selecting the channel access configuration may include selecting or determining a channel access type. In some aspects, UE B may select the channel access type based on the SL communication. For example, UE B may select the channel access type based on COT sharing information. In some aspects, the COT sharing information may be provided in the SL communication received at action 606. In other aspects, the COT sharing information may be provided in a different SL communication from a different UE. In some aspects, the COT sharing information may include COT sharing information associated with a plurality of COTs and/or a plurality of other UEs. In some aspects, the COT sharing information may indicate, to UE B, that a COT associated with the PSFCH occasion may be shared with UE B. In another aspect, the COT sharing information may indicate, to UE B, that a COT associated with the PSFCH occasion cannot be shared with UE B. In some aspects, the COT sharing information may indicate, to UE B, that the PSFCH occasion is not within a shared portion of a COT.

In some aspects, based on the COT not being in a shared portion of a COT, UE B may determine or select a type 1 channel access procedure. In some aspects, the type 1 channel access procedure may include a CAT4 LBT. In some aspects, action 608 may include selecting one or more channel access parameters based on a smallest UL channel access priority class value. In this regard, the UL channel access priority class values and their relevant parameters are provided in the appendix as table 1. In this regard, UE B may select or determine one or more of a contention window size, a maximum COT length, and/or any other suitable parameter shown in table 1 associated with the smallest UL channel access priority class value (e.g., 1). In some aspects, action 608 may include selecting one or more channel access parameters based on a smallest DL channel access priority class value. In this regard, the DL channel access priority class values and their relevant parameters are provided in the appendix as table 2. In this regard, UE B may select or determine one or more of a contention window size, a maximum COT length, and/or any other suitable parameter shown in table 2 associated with the smallest DL channel access priority class value (e.g., 1). In another aspect, action 608 may include selecting one or more channel access parameters based on a smallest PSFCH channel access priority class value. In this regard, exemplary PSFCH channel access priority class values and their relevant parameters are provided in the appendix as table 3. In another aspect, the SL communication may indicate, or be associated with, a channel access priority class. In some aspects, action 608 may include selecting one or more channel access parameters based on the indicated channel access priority class.

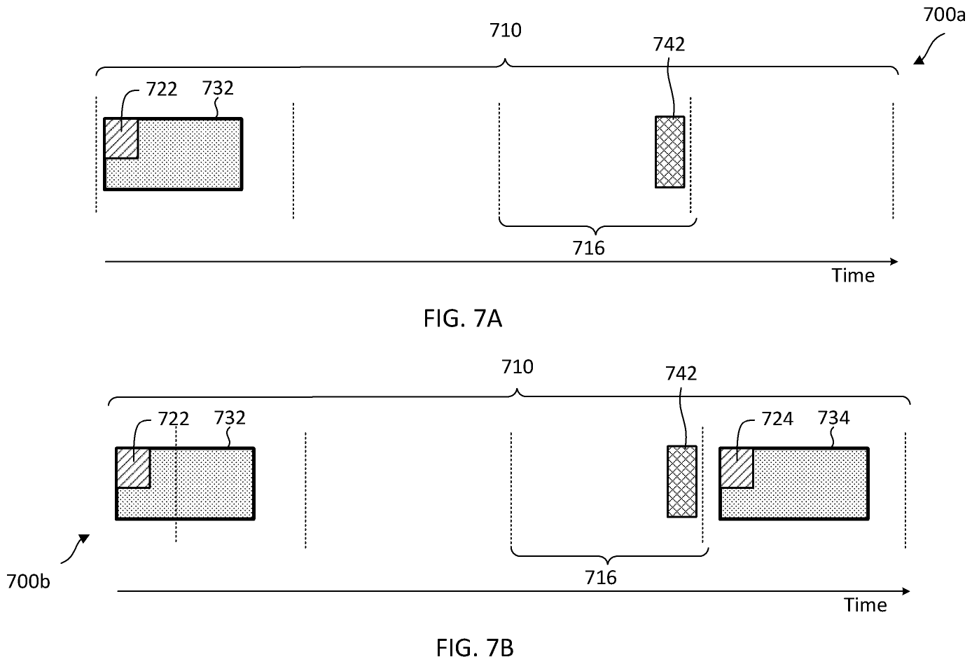

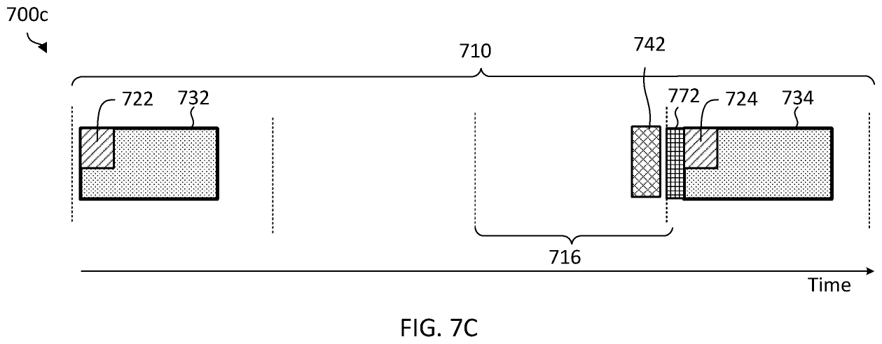

In this regard, FIG. 7A illustrates a PSFCH communication scheme 700a in which a channel access priority class (CAPC) value for a PSFCH occasion is indicated in an SL communication. Aspects of the scheme 700a may be performed by UE A and/or UE B, for example. In the scheme 700a, UE A may transmit a first SL communication comprising SCI carried in a PSCCH 722, and SL data carried in a PSSCH 732. The communications may occur during a period 710 comprising a plurality of slots. In this regard, the SL communication may occur during a first slot of the period 710 and the PSFCH occasion 742 may occur within a third slot 716. In some aspects, the SCI in the PSCCH 722 may indicate a CAPC value for a PSFCH occasion 742. Accordingly, UE B may determine the CAPC and corresponding type 1 channel access parameters based on the indicated CAPC value.

In another aspect, UE B may be scheduled to transmit, immediately following the transmission of a PSFCH in the PSFCH occasion, a second SL communication. For example, UE B may be scheduled to transmit the second SL communication in the slot following the PSFCH occasion. The second SL communication may include a PSCCH communication, a PSSCH communication, a reference signal, and/or a combination thereof. In some aspects, the second SL communication may be associated with a channel access priority class. Accordingly, in some examples, UE B may select the channel access configuration based on the channel access priority class associated with the second SL communication. In some aspects, UE B may perform a type 1 channel access procedure before transmitting the PSFCH communication in the PSFCH occasion (described further below), and may continue with transmitting the second SL communication after the PSFCH communication without performing additional channel sensing and/or without performing an additional channel access procedure for the second SL communication.

In this regard, FIG. 7B illustrates a PSFCH communication scheme 700b in which a CAPC value for a PSFCH occasion may be indicated and/or determined based on a scheduled SL communication. Aspects of the scheme 700b may be performed by UE A and/or UE B, for example. In the scheme 700b, UE A may transmit a first SL communication comprising SCI carried in a PSCCH 722, and SL data carried in a PSSCH 732. The communications may occur during a period 710 comprising a plurality of slots. In this regard, the first SL communication may occur during a first slot of the period 710 and the PSFCH occasion 742 may occur within a third slot 716. UE B may be scheduled to transmit a second SL communication comprising a second PSCCH 724 and a second PSSCH 734 in a slot immediately following the PSFCH occasion 742.

In some aspects, UE B may transmit the second SL communication with a cyclic prefix extension to at least partially fill at least one gap symbol between the PSFCH occasion and the beginning of the second SL communication. In some aspects, UE B may transmit the second SL communication without performing an additional channel access procedure if a channel access priority class value associated with the PSFCH communication is determined based on a channel access priority class value associated with the second SL communication.

FIG. 7C illustrates a PSFCH communication scheme 700c in which a UE may transmit a SL communication after transmitting a PSFCH communication without additional channel sensing. Similar to the schemes 700a, 700b, in the scheme 700c, UE A transmits, and UE B receives, a first SL communication comprising a first PSCCH 722 and a first PSSCH 732 in a first slot within a period 710. UE A may transmit, based on the first SL communication, a PSFCH in a PSFCH occasion 742 in a third slot 716 of the period 710. In some aspects, UE B may perform a channel access procedure before transmitting the PSFCH. In some aspects, UE B may perform a type 1 channel access procedure before transmitting the PSFCH. In another aspect, UE A may share a portion of a COT with UE B so that UE B may perform a type 2 channel access procedure instead of a type 1 channel access procedure. In some aspects, the period 710 represents a COT acquired by UE A. In some aspects, UE B may perform a type 1 channel access procedure based on a CAPC value, as explained above. The CAPC value may be indicated in SCI carried in the first PSCCH 722, for example. In another aspect, the CAPC value may be based on a PSFCH configuration for UE B.

The second SL communication comprising a second PSCCH 724 and a second PSSCH 734 may be associated with a CAPC value. The CAPC value for the second SL communication may be the same as or different from the CAPC value for the PSFCH occasion 742. In some aspects, UE B may be configured to transmit the second SL communication without additional channel sensing or channel access procedures if the CAPC value for the PSFCH occasion 742 is equal to or larger than the CAPC value for the second SL communication. In other aspects, UE B may be configured to transmit the second SL communication for any combination of CAPC values of the PSFCH occasion 742 and the second SL communication by closing a gap between the PSFCH occasion 742 and the second SL communication. In this regard, UE B may be configured to append a CP extension 772 before the second SL communication to at least partially close at least one gap symbol between the PSFCH occasion 742 and the second SL communication.

Referring again to FIG. 6, in another aspect, action 608 may include UE B selecting the channel access procedure based on a PSFCH configuration. In some aspects, the method 600 may include UE B receiving an information element, control element, and/or any other suitable configuration including or indicating the PSFCH configuration. The PSFCH configuration may include or indicate the time and/or frequency resources for PSFCH occasions. In some aspects, the PSFCH configuration may include or indicate at least one of a PSFCH periodicity, a total duration of PSFCH transmissions within an observation period, a number of PSFCH transmissions within an observation period, a duration of each PSFCH occasion or communication, and/or any other suitable parameter. In some aspects, the parameters indicated above may be indicated for or associated with a SCS. For example, a PSFCH configuration for a SCS of 15 kHz and a PSFCH periodicity of 1 may indicate 50 PSFCH transmissions within a 50 ms observation period. The PSFCH configuration for a SCS of 30 kHz and a PSFCH periodicity of 1 may indicate 100 PSFCH transmissions within the 50 ms observation period. In some aspects, action 608 may include UE B selecting the channel access configuration based on the PSFCH configuration. In some aspects, UE B may select the channel access configuration based on one or more of the PSFCH parameters stated above, including the PSFCH periodicity, the total duration of PSFCH transmissions within the observation period, the number of PSFCH transmissions within the observation period, the duration of each PSFCH occasion or communication, and/or any other suitable parameter.

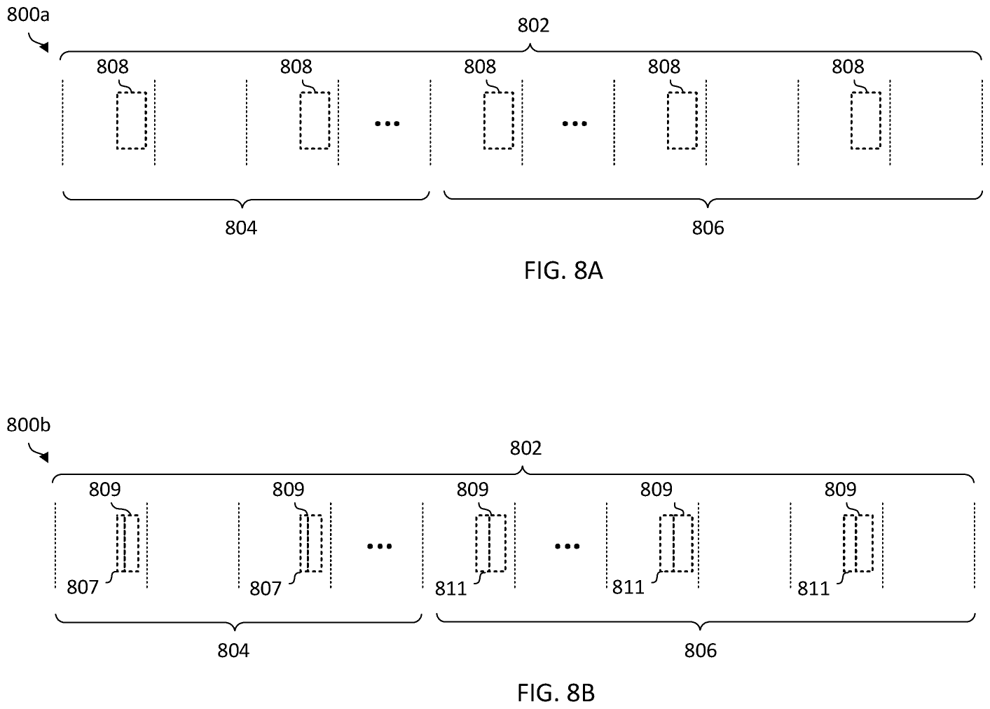

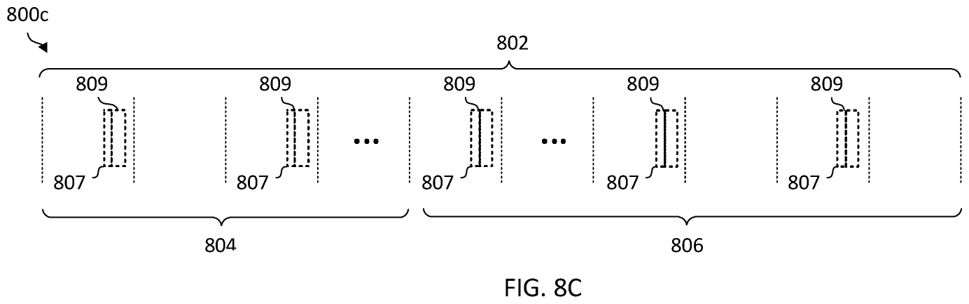

In some aspects, action 608 may include UE B selecting a channel access configuration with no channel sensing based on the PSFCH configuration. For example, UE B may select a type 2C channel access configuration, or a no-sensing channel access configuration, based on the configured PSFCH periodicity being at or above a configured threshold. In this regard, FIG. 8A illustrates a PSFCH configuration 800a in which a plurality of PSFCH occasions 808 occur within a observation period 802. In some aspects, the observation period 802 may have a duration of 50 ms. In other aspects, the observation period 802 may have a duration of 100 ms. However, other durations for the observation period 802 are also contemplated by the present disclosure. In the illustrated example, the PSFCH configuration 800a has a PSFCH periodicity of 2 slots. Accordingly, there is one PSFCH occasion 808 for every two slots in the observation period 802. As explained above, UE B may be configured with a short control signaling configuration that allows for transmission of some short signals that satisfy one or more thresholds or other short control signaling criteria. In some aspects, short control signaling criteria may be satisfied for a first portion 804 of the observation period 802 by the configuration 800a, but not for a second portion 806. Accordingly, UE B may be configured to transmit PSFCH for the occasions 808 in the first portion 804 of the observation period 802 without performing additional channel access procedures. However, UE B may not rely on the short control signaling configuration for the second portion 806 of the observation period 802. For example, UE B may be configured to perform type 1 channel access for the PSFCH occasions 808 in the second portion 806 of the observation period 802. In one example, if the PSFCH configuration 800a indicated a PSFCH periodicity of four slots, UE B may be allowed to transmit PSFCH communications in every PSFCH occasion 808 of the observation period 802 without performing additional channel access procedures or channel sensing (e.g., type 2C channel access).

In some aspects, UE B may select the type 2C channel access configuration based on one or more short control signaling conditions, thresholds, or other parameters being satisfied. In another aspect, UE B may select the type 2C channel access based on the number of PSFCH transmissions within the observation period satisfying a threshold. In other aspects, UE B may select the type 2C channel access based on the total duration of PSFCH transmissions within the observation period satisfying a threshold. For example, UE B may select, for FR1, the type 2C channel access based on the number of PSFCH transmissions within the observation period being equal to or less than 50 and the total duration of PSFCH transmissions in the observation period being less than 2.5 ms. In another example, UE B may select, for FR2, the type 2C channel access based on the total duration of PSFCH transmissions in the observation period being less than 10 ms.

In some aspects, UE B may select type 2C channel access for one or more PSFCH occasions within an observation period based on the PSFCH configuration, but may select type 1, type 2A, or type 2B channel access for one or more other PSFCH occasions during the observation period, as described above with respect to FIG. 8A. For example, the method 600 may include selecting a type 2C channel access procedure for the PSFCH occasion, and selecting a type 1 channel access procedure, a type 2A channel access procedure, or a type 2B channel access procedure for a second PSFCH occasion different from the PSFCH occasion. In some aspects, UE B may be configured to determine or identify a first portion of the observation period in which type 2C channel access is selected, and a second portion in which a different type of channel access is selected. For example, the first portion of the observation period may be determined or identified based on the PSFCH occasions or communications satisfying one or more short control signaling conditions in the first portion. UE B may select type 1, type 2A, or type 2B channel access for the PSFCH occasions in the remaining second portion of the observation period. Table 4 in the Appendix shows durations and other parameters of an observation window in FR1 for which no sensing (e.g., type 2C channel access) may be used. As shown in table 4, UE B may select either a first portion or a second (last) portion of the observation period for no sensing (type 2C channel access) or for other channel access types.

In another aspect, the PSFCH configuration may indicate a partial automatic gain control (AGC) symbol for one or more PSFCH occasions in an observation window. In some aspects, the PSFCH configuration may indicate partial AGC symbols for every PSFCH occasion in the observation period. In other aspects, the PSFCH configuration may indicate a partial AGC symbol for only a portion of the observation period. In this regard, table 5 in the Appendix shows that other periodicities other than 4 may qualify for no-sensing channel access (e.g., type 2C channel access) if partial AGC symbols are used for PSFCH transmission. In this regard, the PSFCH configuration may indicate UE B to use type 2C channel access for PSFCH periodicities of 4 or 2 for SCS values of 15 kHz and 30 kHz if partial AGC symbols are used. In another aspect, the PSFCH configuration may indicate UE B to use type 2C channel access for a first portion of the observation period and a different type of channel access procedure with sensing (e.g., type 1, type 2A) for a second portion of the observation period. In this regard, the use of partial AGC symbols may increase the duration of the portion of the observation period for which type 2C channel access may be used. In addition, the AGC symbol length may be sufficiently long to ensure AGC training performance. For example, in some aspects, the PSFCH configuration may indicate UE B to use ⅔ of a OFDM symbol for AGC with one or more PSFCH transmissions. In other aspects, the PSFCH configuration may indicate UE B to use ½ of a OFDM symbol for AGC with one or more PSFCH transmissions. The PSFCH configuration may indicate UE B to use partial AGC symbols for all PSFCH occasions during an observation period, or for only a portion of the observation period.

FIGS. 8B and 8C illustrate PSFCH configurations 800b, 800c with partial AGC symbols. For example, referring to FIG. 8B, the configuration 800b includes a plurality of PSFCH occasions comprising resources for a PSFCH symbol 809 and AGC symbols 807, 811 within an observation period 802. In some aspects, a first portion 804 of the observation period 802 comprises PSFCH occasions where partial AGC symbols 807 are used. The second portion 806 of the observation period 802 includes PSFCH occasions where full AGC symbols 811 are used. In some aspects, using partial AGC symbols 807 may increase the number of PSFCH communication that can be transmitted with no additional channel access procedures or channel sensing within the observation period 802, relative to the configuration 800a where full AGC symbols may be used for all PSFCH occasions 808. As stated above, the partial AGC symbols 807 may occupy ⅔, ½, or any other suitable portion of a full OFDM symbol. Referring to FIG. 8C, the PSFCH configuration 800c involves the use of partial AGC symbols 807 for all PSFCH occasions in the observation period 802. In some aspects, using partial AGC symbols 807 for the entire observation period 802 may increase the number of PSFCH that can be communicated based on the short control signaling criteria and without additional channel access procedures.

At action 610, UE B performs a channel access procedure based on the channel access type or configuration selected at action 608. In some aspects, the channel access procedure may include or involve channel sensing. In other aspects, the channel access procedure may include or involve no channel sensing (e.g., type 2C channel access). In some aspects, action 610 may include UE B performing the channel access procedure based on type 1 channel access parameters selected based on at least one of a lowest UL CAPC value, a lowest DL CAPC value, or a lowest PSFCH CAPC value, as explained above. In some aspects, UE B may perform no channel sensing at action 610. For example, UE B may select a type 2C channel access procedure at action 608 for the PSFCH occasion. In other aspects, UE B may perform the channel access procedure based on an indication of a channel access type transmitted by UE A. In another aspect, UE B may perform the channel access procedure based on an indication of a channel access type transmitted by the network via a network entity.

At action 612, UE B transmits, based on the channel access configuration selected at action 608 and the SL communication received at action 606, a PSFCH communication in the PSFCH occasion in the shared frequency band. In some aspects, transmitting the PSFCH communication may include transmitting an AGC symbol and a PSFCH symbol during the PSFCH occasion and based on the PSFCH configuration. In some aspects, a plurality of PSFCH communications may be simultaneously transmitted at action 612. Each PSFCH may be mapped to a corresponding PSSCH received from UE A and/or other UEs. In some aspects, the PSFCH may be transmitted in one or more resource blocks (RBs). In some aspects, the PSFCH may be transmitted in one or more RB interlaces, where each interlace comprises a plurality of RBs spaced from one another by at least one other RB corresponding to a different RB interlace.

At action 614, UE B transmitting a second SL communication after transmitting the PSFCH communication. In some aspects, UE B may transmit the second SL communication after transmitting the PSFCH communication without performing additional channel sensing. For example, UE B may perform a type 1 channel access procedure before transmitting the PSFCH communication, and may transmit the second SL communication based on the type 1 channel access procedure performed for the PSFCH communication. In some aspects, transmitting the second SL communication may include transmitting the second SL communication with a cyclic prefix (CP) extension in at least one gap symbol between the PSFCH communication and the second SL communication. In some aspects, transmitting the second SL communication may be based on at least one of a first CAPC value for the PSFCH communication and a second CAPC value for the second SL communication. In some aspects, UE B may transmit the second SL communication without additional sensing if the first CAPC value for the PSFCH communication is equal to or larger than the second CAPC value for the second SL communication.

In some aspects, transmitting the PSFCH communication may include transmitting the PSFCH communication using a partial AGC symbol preceding a PSFCH symbol. In some aspects, transmitting the PSFCH communication may include transmitting ⅔ of an AGC symbol, ½ of an AGC symbol, or any other suitable portion of an AGC symbol with the PSFCH symbol. In other aspects, transmitting the PSFCH communication may include transmitting a full AGC symbol with the PSFCH symbol. In some aspects, UE B may transmit the PSFCH communication with no channel sensing based on one or more short control signaling configurations or parameters, as explained above.

In some aspects, a UE may initiate a COT and share the COT with a receiving UE. The receiving UE may use a shared portion of the COT for transmitting PSFCH. In some aspects, the UE that initiates or acquires the COT may indicate a channel access type to the receiving UE. The COT-initiating UE may also indicate whether a CP extension should be used for PSFCH communications, a CAPC value for the PSFCH communications, and/or any other associated parameter for PSFCH communications. For example, the COT-initiating UE may indicate to the receiving UE to use type 2 channel access for PSFCH communications. In some aspects, the COT-initiating UE may indicate COT sharing information and/or channel access type and other parameters in SCI. However, there may be challenges and issues with indicating channel access type and sharing COTs. For example, a UE transmitting a PSCCH/PSSCH with a channel access type indication may not be able to determine or correctly predict whether a PSFCH communication from the receiving UE will be transmitted in a shared portion of a COT. For example, the transmitting UE may not be the COT-initiating or COT-sharing UE. Further, a receiving UE may receive conflicting and/or contradictory COT sharing indications or channel access indications for a PSFCH occasion. Further, a transmitting UE may indicate a type 1 channel access to the receiving UE based on the transmitting UE determining that a PSFCH occasion is not within a shared portion of the transmitting UE's COT. However, the receiving UE may subsequently receive COT sharing information from a different transmitting UE indicating that the PSFCH occasion is within a shared portion of a COT. Accordingly, the type 1 channel access procedure indicated by the first transmitting UE may be unnecessary.

The present disclosure also describes systems and methods for channel access type determination and PSFCH communication based on indications communicated from one or more UEs. For example, in some aspects, a COT-initiating UE may be configured to transmit, to one or more UEs, COT sharing information in SCI indicating that the COT-initiating UE will share a portion of the COT with one or more UEs. Accordingly, a UE transmitting PSSCH may determine that the receiving UE's PSFCH may be in a portion of the shared COT from the COT-initiating UE, and indicate a channel access type in accordance with the COT sharing information. In other examples, a COT-initiating UE may indicate that a COT is unavailable for sharing with one or more other UEs. In another example, a COT-initiating UE may indicate that at least one UE may share a COT and that at least one other UE may not share the COT.

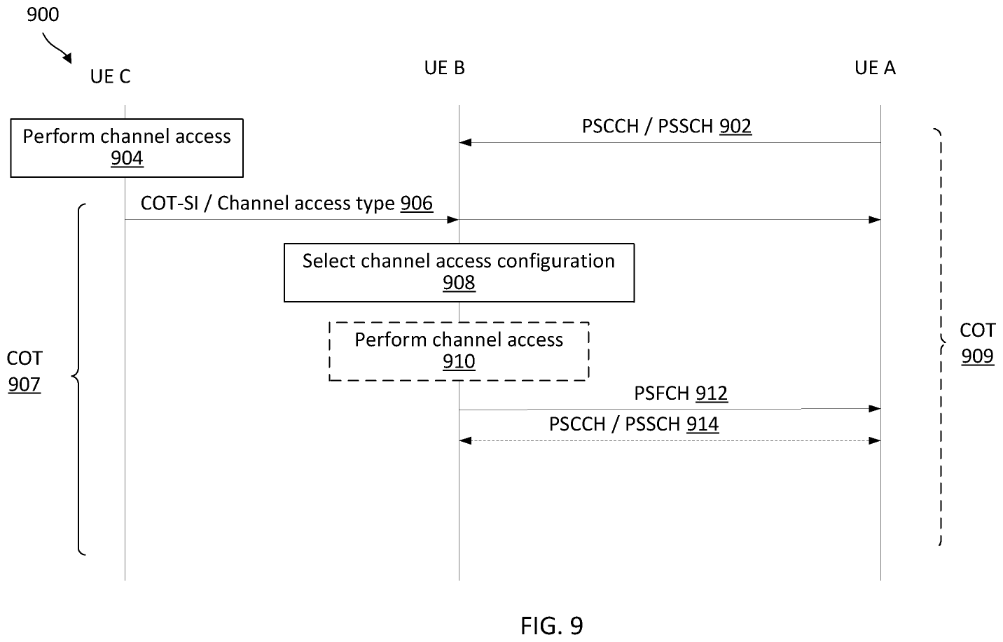

FIG. 9 is a signaling diagram of a method 900 for wireless communication performed by a first UE (UE A), a second UE (UE B), and a third UE (UE C). The UEs A, B, and/or C may be UEs 115 in the network 100 and/or UEs 215 in the network 200. The method 900 may include aspects of the schemes and configurations shown in FIGS. 6-8C. The method 900 may include the UEs A, B, and C communicating via a sidelink interface in a shared frequency band. For example, the method 900 may include communicating using a SL-U protocol. In some aspects, the UEs A, B, and/or C may communicate using a PC5 interface. As mentioned above, to communicate in shared or unlicensed frequency resources, one or more of the UEs A, B, and/or C may perform a clear channel assessment (CCA), such as a listen-before-talk (LBT) to acquire a set of time resources in a frequency band or subband. The time resources may be referred to as a channel occupancy time (COT).

At action 902, UE A transmits, and UE B receives, a SL communication comprising at least one of a PSCCH or a PSSCH. In some aspects, the SL communication comprises the PSCCH carrying SCI and a PSSCH carrying additional SCI and/or SL data. In some aspects, the SCI may indicate, to UE B, COT sharing information of a COT 909 acquired by UE A. The dashed-line bracket for the COT 909 may indicate that the COT 909 is optional in the method 900. In another aspect, the SCI transmitted at action 902 may indicate, to UE B, a channel access type for at least one PSFCH occasion associated with the PSSCH. For example, in some aspects, UE A may indicate, to UE B, that the COT 909 is unavailable for sharing with UE B. In another aspect, the SCI may indicate UE B to perform a type 1 channel access procedure for at least the PSFCH associated with the PSSCH communicated at action 902.

At action 904, UE C performs a channel access procedure to initiate or acquire a COT. In some aspects, the channel access procedure may be a type 1 channel access procedure. For example, UE C may perform a CAT4 LBT with a random backoff period. Based on the channel access procedure, UE C initiates a COT 907. The COT 907 may include a time period during which UE C may communicate with one or more UEs in the network, including UE A and/or UE B. In some aspects, the time period may be configured as a value of absolute time units, such as ms or ps. In another aspect, the time period may be configured as a value of frames, subframes, and/or slots.

At action 906, UE C communicates, to at least one of UE B and/or UE A, COT sharing information (SI) and/or a channel access type indication. In some aspects, the UE C may indicate that the COT 907 is available to share with at least one of UE A and/or UE B. In other aspects, the COT-SI may indicate that the COT-SI is unavailable to share with at least one of UE A and/or UE B. In some aspects, action 906 includes UE C indicating, to at least one of UE A and/or UE B, a channel access type for PSFCH communications within the COT 907. For example, UE C may indicate UE A and/or UE B to perform a type 2 channel access procedure, such as type 2A or type 2B channel access. In another aspect, UE C may indicate UE A and/or UE B to perform a type 2C channel access procedure such that no additional channel sensing is performed before transmitting a PSFCH.

At action 908, UE B selects or determines, based on at least one of the COT-SI or channel access type indication received at action 906, or the PSCCH/PSSCH received at action 902, a channel access configuration or type for a PSFCH occasion. In some aspects, UE B may select a channel access type based on the COT-SI provided by UE C. For example, UE B may select a channel access type 2 based on UE C indicating that the COT 907 will be shared with UE B, with the PSFCH occasion being within the shared portion of the COT 907. In another aspect, UE B may select a channel access type 1 based on UE C indicating that the COT 907 will not be shared with UE B. In another aspect, UE B may select the channel access type based on the indication provided by UE C at action 906. In another aspect, UE B may select the channel access type based on an indication provided by UE A in action 902. In other aspects, UE B may select the channel access type based on COT-SI provided by UE A in the PSCCH communicated at action 902.

In some aspects, COT-SI may include or indicate at least one of the COT duration and available RB sets for sharing. In some aspects, the COT duration may indicate a length from the beginning of the slot where the COT sharing information is received. In another aspect, the available RB sets indicated in the COT-SI may be available or valid until the end of the COT. Similarly, if the COT-SI indicates that COT sharing is not available, or that at least a portion of the COT is not available to share, the COT-SI may indicate at least one of the duration or time domain location of the unavailable portion(s) of the COT and/or the unavailable RB sets. In some aspects, if the available/unavailable RB sets are not indicated in the COT-SI, UE B may assume that all RB sets within the COT are not shareable. Further, in some aspects, the COT-SI may indicate a combination of COT sharing information and COT sharing unavailability information. For example, the cot sharing information may indicate both a shareable portion of the cot and an unavailable portion of the cot. In some aspects, the COT sharing information may indicate one or more UEs that may share a portion of the cot, and one or more other UEs that may not share a portion of the cot.

The COT sharing information or unavailability information maybe indicated in SCI. For example, the COT sharing information may be indicated in a SCI 2 format. In some aspects, the COT sharing information may be provided in a SCI-2C format. In other aspects, a new SCI format may be defined and/or configured for indicating COT sharing and/or unavailability information. If SCI-2C is used, UE B may be configured to distinguish whether the SCI-2C indicates inter-UE coordination information or COT sharing and/or unavailability information. In some aspects, an SCI-2C may indicate that the SCI includes COT sharing information based on a bit value of at least one of the SCI-2C fields. For example, SCI-2C may include a reference slot field. In some aspects, if the reference slot field is set to all 0's or all 1's, the SCI-2C may indicate that the SCI includes COT sharing information. In some aspects, a TRIV field of the SCI-2C may be used to indicate a COT duration or a duration of a shared portion of the COT. In another aspect, at least one of a FRIV field and/or a first sub-channel field of the SCI-2C may indicate the available or unavailable RB sets for COT sharing. In another aspect, a set type field of the SCI-2C may be used to indicate whether the SCI-2C is a COT sharing indication or a COT unavailability indication. In other aspects, different time resource indicator value (TRIV), frequency resource indicator value (FRIV), and/or first sub-channel fields may be defined in the SCI for indicating a combination of COT sharing and COT unavailability information.

In another aspect, an SCI format may be provided to include at least one of a COT sharing indication field, a COT unavailability filed, a COT duration field, a RB sets field, and/or any other suitable field. In some aspects, the COT duration field may be configured by RRC or PC5-RRC. In another aspect, a set of COT duration values for the COT duration field may be configured by RRC or PC5-RRC. The COT duration field may indicate one of the configured values, for example. In another aspect, an additional field may be included in the SCI to indicate whether the SCI is a COT sharing indication or a COT unavailability indication.

In some aspects, action 908 may include UE B selecting a type 2A channel access type in response to receiving a COT sharing indication from at least one of UE A or UE C indicating that the PSFCH occasion is scheduled for a shared portion of a COT. In other aspects, action 908 may include UE B selecting a type 1 channel access type in response to receiving a COT unavailability indication from at least one of UE A or UE C, or based on the PSFCH occasion being scheduled outside a shared portion of a COT. In some aspects, UE B may receive multiple COT sharing information indications from different UEs, such as UE A and UE C. In some aspects, the COT durations may occur in an overlapping time period. In other aspects, the shared COTs may not overlap. In some aspects, only one of the shared COTs occurs during the PSFCH occasion. In other aspects, both or neither of the shared COTs occur during the PSFCH occasion. Action 908 may include UE B selecting or following one of multiple COT sharing indications. In some aspects, UE B may select the COT-SI indication received in the most recent or latest SCI. In another aspect, UE B may select or follow union COT sharing information. For example, UE B may select the channel access type based on a combination of the COT sharing information provided by UE A and UE C. In this regard, if a first shared COT occurs completely within a longer second shared COT, UE B may select a channel access type based on the COT sharing information associated with the longer second shared COT. In another aspect, UE B may treat as an error case for a scenario in which the multiple COT sharing indications are provided by a same UE and multiple COT sharing indications indicate different COT sharing information.

According to another aspect, action 908 may include UE B selecting the channel access type based on two or more channel access type indications provided by at least one of UE A or UE C. In some aspects, UE B may select, for the PSFCH occasion, an indicated channel access type that is associated with the shortest sensing duration. For example, if UE B receives, for the same PSFCH occasion, channel access type indications for both type 2B channel access and type 2A channel access, UE B may select type 2B channel access. In another example, if UE B receives, for the same PSFCH occasion, channel access type indications for both type 1 channel access and type 2A channel access, UE B may select type 2A channel access. In another example, if UE B receives, for the same PSFCH occasion, channel access type indications for both type 2B channel access and type 2C channel access, UE B may select type 2C channel access. In another aspect, UE B may select the channel access type indicated in the most recently-received SCI for PSFCH communications in the same slot and same channel access bandwidth. In another example, action 908 may include UE B treating conflicting channel access type indications as an error case. Accordingly, UE B may be configured to select type 1 channel access, for example, if UE B receives different channel access type indications associated with a same PSFCH occasion. In another aspect, UE B may be configured to select the channel access type for the PSFCH occasion based on an indication from at least one of UE A or UE C indicating a request to share a COT acquired by UE B for the PSFCH transmission. Accordingly, UE B may select type 1 channel access in response to receiving the indication, and may indicate to UE A and/or UE C that a remaining portion of the acquired COT is available to share for other communications from UE A and/or UE C.

In another aspect, UE B may select the channel access type based on an indication from UE A and/or UE C enabling or disabling UE B to use a channel access type indication from another UE. For example, UE C may transmit to UE B, a signal indicating that UE B may use the channel access type indicated by UE C for PSFCH transmission to another UE, e.g., UE A. In some aspects, the signal may include a SCI. For example, the SCI may include a field indicating whether UE B is enabled or disabled to use a channel access indication from UE C to transmit PSFCH communications to UE A.

In another aspect, UE B may receive COT sharing information from UE A that conflicts with a channel access type indication from UE C. For example, UE A may transmit COT sharing information indicating UE B to share a portion of UE A's COT to transmit the PSFCH. UE B may be configured to use type 2A channel access for PSFCH communications in a shared portion of a COT. However, UE C may transmit SCI to UE B indicating UE B to use a different channel access type for the PSFCH occasion that occurs within the shared portion of UE A's COT. For example, UE C may indicate UE B to use type 1 channel access or type 2B channel access. According to aspects of the present disclosure, action 908 may include UE B selecting a channel access type based on one or both of the conflicting indications.

For example, action 908 may include UE B receiving COT sharing information associated with a first channel access type for a PSFCH occasion from UE A, and a channel access type indication from UE C indicating a second channel access type different from the first channel access type. In some aspects, action 908 may include UE B selecting the channel access type having the shorter sensing duration for PSFCH transmissions. In another aspect, UE B may select the channel access type associated with the most recently-received SCI. For example, if the most recently-received SCI comprises COT sharing information for a COT in which the PSFCH occasion is scheduled, UE B may select type 2A channel access based on the indication of the shared COT. In another example, if the most recently-received SCI comprises an indication of type 1 channel access, UE B may select type 1 channel access even if the PSFCH occasion occurs during a shared portion of a COT. In another aspect, UE B may treat the conflicting indications of COT sharing and channel access as an error case. For example, UE B may be configured to select type 1 channel access in the event that conflicting indications of channel access types are received by UE B. In another aspect, UE B may be configured to select the channel access type for the PSFCH occasion based on an indication from at least one of UE A or UE C indicating a request to share a COT acquired by UE B for the PSFCH transmission. Accordingly, UE B may select type 1 channel access in response to receiving the indication, and may indicate to UE A and/or UE C that a remaining portion of the acquired COT is available to share for other communications from UE A and/or UE C. In other words, if UE B receives from UE A an indication to use type 2A channel access for a PSFCH occasion, and UE C indicates to UE B a request to share a COT acquired for the PSFCH transmission, UE B may select type 1 channel access based on UE C's indication and share a portion of the COT with UE C.

At action 910, UE B performs a channel access procedure based on the channel access configuration or channel access type selected at action 908. In some aspects, action 910 may comprise UE B performing channel sensing. For example, action 908 may comprise UE B performing a type 1, type 2A, or type 2B channel access procedure. In another aspect, action 908 may not include channel sensing. For example, action 908 may comprise UE B performing a type 2C channel access procedure. In another example, the method 900 may not include the channel access procedure at action 910. For example, UE B may be configured to transmit a PSFCH communication based on a short control signaling configuration such that no channel sensing is performed. In this regard, action 910 is shown as a dashed box. The dashed box may represent that no channel sensing or channel access procedure is performed before transmitting the PSFCH.

At action 912, UE B transmits, based on the channel access configuration selected at action 908 and the SL communication received at action 902, a PSFCH communication in the PSFCH occasion in the shared frequency band. In some aspects, transmitting the PSFCH communication may include transmitting an AGC symbol and a PSFCH symbol during the PSFCH occasion and based on the PSFCH configuration. In some aspects, a plurality of PSFCH communications may be simultaneously transmitted at action 912. Each PSFCH may be mapped to a corresponding PSSCH received from UE A, UE C, and/or other UEs. In some aspects, the PSFCH may be transmitted in one or more resource blocks (RBs). In some aspects, the PSFCH may be transmitted in one or more RB interlaces, where each interlace comprises a plurality of RBs spaced from one another by at least one other RB corresponding to a different RB interlace.

At action 914, UE B may communicate, immediately following the transmission of the PSFCH communication at action 912, a PSCCH and PSSCH communication with UE A. In some aspects, action 914 comprises UE B transmitting the PSCCH/PSSCH to UE A. For example, in some aspects, UE B may perform a type 1 channel access procedure to acquire a COT for the PSFCH occasion. UE B may transmit the PSCCH/PSSCH communication immediately following the PSFCH communication. In some aspects, UE B may transmit the PSCCH/PSSCH without performing additional channel sensing between the PSFCH and the PSCCH/PSSCH. For example, UE B may append a CP extension to at least partially fill a gap between the PSFCH and the PSCCH/PSSCH. In other aspects, action 914 may comprise UE A transmitting the PSCCH/PSSCH to UE B. For example, as mentioned above, the method 900 may comprise UE A indicating UE B to acquire a COT for the PSFCH and to share the COT with UE A to receive the PSCCH/PSSCH from UE A.

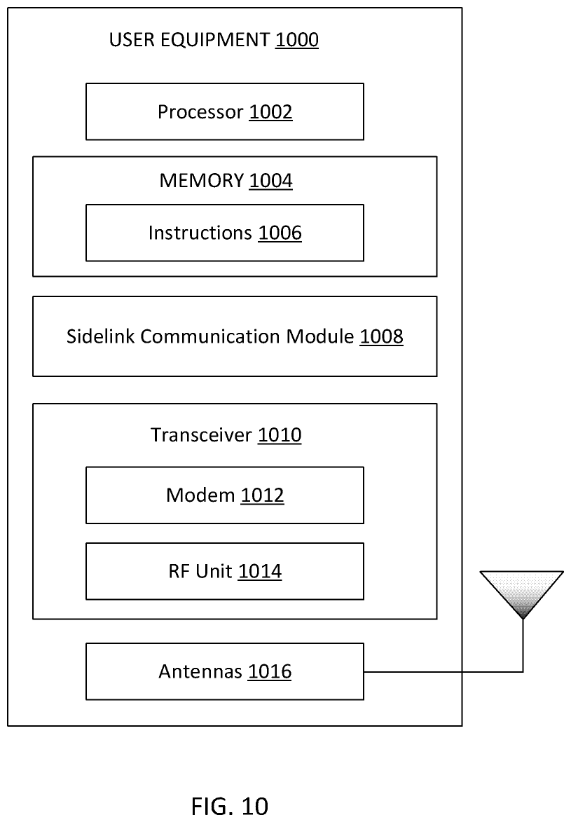

FIG. 10 is a block diagram of an exemplary UE 1000 according to some aspects of the present disclosure. The UE 1000 may be a UE 115 discussed above in FIG. 1 or a UE 215 discussed above in FIG. 2. As shown, the UE 1000 may include a processor 1002, a memory 1004, a sidelink communication module 1008, a transceiver 1010 including a modem subsystem 1012 and a radio frequency (RF) unit 1014, and one or more antennas 1016. These elements may be in direct or indirect communication with each other, for example via one or more buses.

The processor 1002 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1004 includes a non-transitory computer-readable medium. The memory 1004 may store, or have recorded thereon, instructions 1006. The instructions 1006 may include instructions that, when executed by the processor 1002, cause the processor 1002 to perform the operations described herein with reference to the UEs 115 in connection with aspects of the present disclosure, for example, aspects of FIGS. 6-9. Instructions 1006 may also be referred to as program code. The program code may be for causing a wireless communication device to perform these operations, for example by causing one or more processors (such as processor 1002) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink communication module 1008 may be implemented via hardware, software, or combinations thereof. For example, the sidelink communication module 1008 may be implemented as a processor, circuit, and/or instructions 1006 stored in the memory 1004 and executed by the processor 1002. In some instances, the sidelink communication module 1008 can be integrated within the modem subsystem 1012. For example, the sidelink communication module 1008 can be implemented by a combination of software components (e.g., executed by a DSP or a general processor) and hardware components (e.g., logic gates and circuitry) within the modem subsystem 1012.

The sidelink communication module 1008 may be used for various aspects of the present disclosure, for example, aspects of FIGS. 6-9. For instance, the sidelink communication module 1008 may be configured to receive a SL communication, select a channel access configuration for a PSFCH occasion in a shared frequency band, and transmit, based on the selected channel access configuration and the SL communication, a PSFCH communication in the PSFCH occasion in the shared frequency band. In some aspects, the sidelink communication module 1008 may be configured to receive the SL communication from a second UE, and select a type 1 channel access procedure based on COT sharing information. For example, the sidelink communication module 1008 may be configured to select the type 1 channel access procedure based on determining that the PSFCH occasion is not within a shared portion of a COT. In other aspect, the sidelink communication module 1008 may be configured to select the channel access procedure based on an indication that the PSFCH occasion is within a shared portion of a COT, or based on a channel access type indication provided by another UE. In some aspects, the sidelink communication module 1008 may be configured to determine or select one or more parameters of a channel access configuration based on an indication of a channel access priority class (CAPC) value.

In other aspects, the sidelink communication module 1008 may be configured to use a short control signaling configuration to transmit the PSFCH communication with no additional channel sensing. For example, the sidelink communication module 1008 may be configured to select a type 2C channel access configuration based on determining that a PSCH configuration satisfies one or more short control signaling criteria. In other aspects, the sidelink communication module 1008 may be configured to select the channel access configuration in response to receiving multiple conflicting indications of channel access, as described above with respect to FIG. 9.

As shown, the transceiver 1010 may include the modem subsystem 1012 and the RF unit 1014. The transceiver 1010 can be configured to communicate bi-directionally with other devices, such as the BSs 105. The modem subsystem 1012 may be configured to modulate and/or encode the data from the memory 1004 and/or the sidelink communication module 1008 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 1014 may be configured to process (e.g., perform analog to digital conversion or digital to analog conversion, etc.) modulated/encoded data (e.g., SCI, sidelink data, RRC IEs) from the modem subsystem 1012 (on outbound transmissions) or of transmissions originating from another source such as a UE 115 or a BS 105. The RF unit 1014 may be further configured to perform analog beamforming in conjunction with the digital beamforming. Although shown as integrated together in transceiver 1010, the modem subsystem 1012 and the RF unit 1014 may be separate devices that are coupled together at the UE 115 to enable the UE 115 to communicate with other devices.

The RF unit 1014 may provide the modulated and/or processed data, e.g. data packets (or, more generally, data messages that may contain one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The transceiver 1010 may provide the demodulated and decoded data (e.g., sidelink configuration, resource pool configuration) to the sidelink communication module 1008 for processing. The antennas 1016 may include multiple antennas of similar or different designs in order to sustain multiple transmission links. The RF unit 1014 may configure the antennas 1016.

In some aspects, the transceiver 1010 is configured to perform an LBT in a shared radio frequency band based on a first starting point of a plurality of starting points within an LBT gap duration and transmit, to a second UE (e.g., the UEs 115, 215, and/or 1000), a first sidelink communication in the shared radio frequency band based on the LBT, the first sidelink communication including first SCI and first sidelink data, for example, by coordinating with the sidelink communication module 1008.

In an aspect, the UE 1000 can include multiple transceivers 1010 implementing different RATs (e.g., NR and LTE). In an aspect, the UE 1000 can include a single transceiver 1010 implementing multiple RATs (e.g., NR and LTE). In an aspect, the transceiver 1010 can include various components, where different combinations of components can implement different RATs.

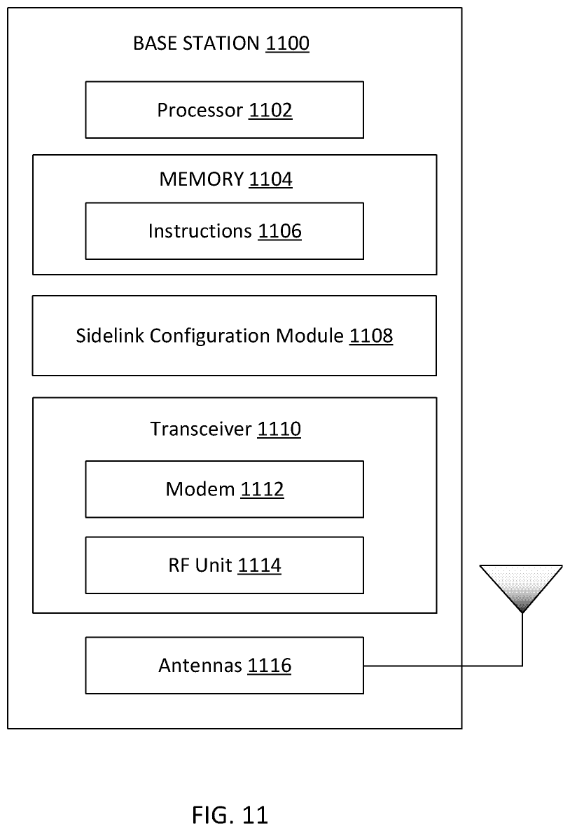

FIG. 11 is a block diagram of an exemplary BS 1100 according to some aspects of the present disclosure. The BS 1100 may be a BS 105 in the network 100 as discussed above in FIG. 1 or a BS 205 in the network 200 as discussed above in FIG. 2. As shown, the BS 1100 may include a processor 1102, a memory 1104, a sidelink configuration module 1108, a transceiver 1110 including a modem subsystem 1112 and a RF unit 1114, and one or more antennas 1116. These elements may be in direct or indirect communication with each other, for example via one or more buses.

The processor 1102 may have various features as a specific-type processor. For example, these may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1104 may include a non-transitory computer-readable medium. The memory 1104 may store instructions 1106. The instructions 1106 may include instructions that, when executed by the processor 1102, cause the processor 1102 to perform operations described herein, for example, aspects of FIGS. 6-9. Instructions 1106 may also be referred to as code, which may be interpreted broadly to include any type of computer-readable statement(s) as discussed above with respect to FIG. 10.

The sidelink configuration module 1108 may be implemented via hardware, software, or combinations thereof. For example, the sidelink configuration module 1108 may be implemented as a processor, circuit, and/or instructions 1106 stored in the memory 1104 and executed by the processor 1102. In some instances, the sidelink configuration module 1108 can be integrated within the modem subsystem 1112. For example, the sidelink configuration module 1108 can be implemented by a combination of software components (e.g., executed by a DSP or a general processor) and hardware components (e.g., logic gates and circuitry) within the modem subsystem 1112.

The sidelink configuration module 1108 may be used for various aspects of the present disclosure, for example, aspects of FIGS. 6-9. For instance, the sidelink configuration module 1108 may be configured to transmit one or more information elements and/or control elements indicating SL resource pool configurations, PSFCH configurations, channel access priority configurations, and/or any other suitable type of configuration. For example, the sidelink configuration module 1108 may be configured to transmit one or more RRC IEs, MAC CEs, and/or any other suitable communication including or indicating these configurations.

As shown, the transceiver 1110 may include the modem subsystem 1112 and the RF unit 1114. The transceiver 1110 can be configured to communicate bi-directionally with other devices, such as the UEs 115 and/or 1000 and/or another core network element. The modem subsystem 1112 may be configured to modulate and/or encode data according to a MCS, e.g., a LDPC coding scheme, a turbo coding scheme, a convolutional coding scheme, a polar coding scheme, a digital beamforming scheme, etc. The RF unit 1114 may be configured to process (e.g., perform analog to digital conversion or digital to analog conversion, etc.) modulated/encoded data (e.g., PDCCH, PDSCH, SSBs, sidelink configuration, sidelink resource pool configuration) from the modem subsystem 1112 (on outbound transmissions) or of transmissions originating from another source such as a UE 115 and/or UE 1000. The RF unit 1114 may be further configured to perform analog beamforming in conjunction with the digital beamforming. Although shown as integrated together in transceiver 1110, the modem subsystem 1112 and/or the RF unit 1114 may be separate devices that are coupled together at the BS 105 to enable the BS 105 to communicate with other devices.

The RF unit 1114 may provide the modulated and/or processed data, e.g. data packets (or, more generally, data messages that may contain one or more data packets and other information), to the antennas 1116 for transmission to one or more other devices. This may include, for example, transmission of information to complete attachment to a network and communication with a camped UE 115 or 1000 according to some aspects of the present disclosure. The antennas 1116 may further receive data messages transmitted from other devices and provide the received data messages for processing and/or demodulation at the transceiver 1110. The transceiver 1110 may provide the demodulated and decoded data to the sidelink configuration module 1108 for processing. The antennas 1116 may include multiple antennas of similar or different designs in order to sustain multiple transmission links.

In an aspect, the BS 1100 can include multiple transceivers 1110 implementing different RATs (e.g., NR and LTE). In an aspect, the BS 1100 can include a single transceiver 1110 implementing multiple RATs (e.g., NR and LTE). In an aspect, the transceiver 1110 can include various components, where different combinations of components can implement different RATs.

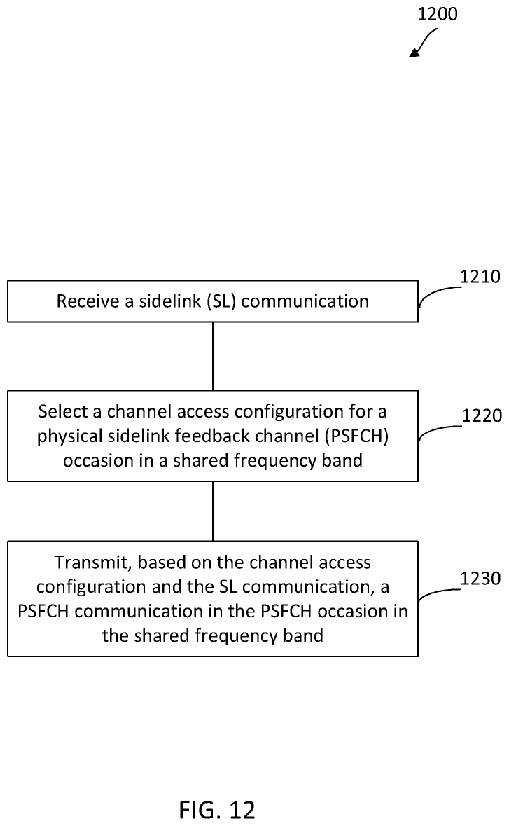

FIG. 12 is a flow diagram of a sidelink communication method 1200 according to some aspects of the present disclosure. Aspects of the method 1200 can be executed by a computing device (e.g., a processor, processing circuit, and/or other suitable component) of a wireless communication device or other suitable means for performing the steps. For example, a wireless communication device, such as the UEs 115, 215, and/or 1000, may utilize one or more components, such as the processor 1002, the memory 1004, the sidelink communication module 1008, the transceiver 1010, the modem 1012, and the one or more antennas 1016, to execute the steps of method 1200. The method 1200 may employ similar mechanisms as in the schemes 600 and/or 900 discussed above with respect to FIGS. 6-9, respectively. As illustrated, the method 1200 includes a number of enumerated steps, but aspects of the method 1200 may include additional steps before, after, and in between the enumerated steps. In some aspects, one or more of the enumerated steps may be omitted or performed in a different order.

At block 1210, the UE receives a sidelink (SL) communication. In some aspects, the SL communication may include SL control information, SL data, reference signals, and/or a combination thereof. For example, the SL communication may include SCI carried in a PSCCH. In some aspects, the SL communication includes SL data carried in a PSSCH. In some aspects, block 1210 may include the UE receiving and decoding SCI in a PSCCH and/or PSSCH, and determining a location of at least one PSSCH associated based on the SCI. In some aspects, the UE may receive the SL communication in a SL resource pool or SL resource allocation. In some aspects, the SL resource pool may include a set of time and frequency resources. The SL resource pool may be semi-statically configured, dynamically configured, statically configured, and/or any other suitable type of resource configuration. In some aspects, the UE may receive the SL communication in a shared frequency band or unlicensed frequency band. In some aspects, the UE may receive the SL communication in a channel occupancy time (COT) associated with a channel access configuration. For example, the UE may receive the SL communication from a second UE within a COT initiated by the second UE. In some aspects, the COT may be initiated by the second UE by performing a channel access procedure. The channel access procedure may correspond to a channel access type. For example, the channel access procedure may be a type 1 channel access procedure, a type 2A channel access procedure, a type 2B channel access procedure, or a type 2C channel access procedure. In some aspects, the UE may share a portion of the COT to transmit PSFCH to the second UE, as explained further below. In other aspects, the UE may not share the COT.

In some aspects, the UE may receive the SL communication within or during a PSFCH period. In some aspects, the PSFCH period may include or extend for one or more slots. In this regard, the UE may be configured with a PSFCH resource configuration indicating a PSFCH periodicity. The PSFCH periodicity may indicate a quantity of slots. In some aspects, the PSFCH periodicity may be one slot, two slots, four slots, eight slots, and/or any other suitable number of slots. SL communications such as PSSCH received during a PSFCH period may be associated with a PSFCH occasion for the PSFCH period.

At block 1220, the UE selects a channel access configuration for a PSFCH occasion in a shared frequency band. In some aspects, selecting the channel access configuration may include selecting or determining a channel access type. In some aspects, the UE may select the channel access type based on the SL communication. For example, the UE may select the channel access type based on COT sharing information. In some aspects, the COT sharing information may be provided in the SL communication received at block 1210. In other aspects, the COT sharing information may be provided in a different SL communication from a different UE. In some aspects, the COT sharing information may include COT sharing information associated with a plurality of COTs and/or a plurality of other UEs. In some aspects, the COT sharing information may indicate, to the UE, that a COT associated with the PSFCH occasion may be shared with the UE. In another aspect, the COT sharing information may indicate, to the UE, that a COT associated with the PSFCH occasion cannot be shared with the UE. In some aspects, the COT sharing information may indicate, to the UE, that the PSFCH occasion is not within a shared portion of a COT.

In some aspects, based on the COT not being in a shared portion of a COT, the UE may determine or select a type 1 channel access procedure. In some aspects, the type 1 channel access procedure may include a CAT4 LBT. In some aspects, block 1220 may include selecting one or more channel access parameters based on a smallest UL channel access priority class value. In this regard, the UL channel access priority class values and their relevant parameters are provided in the appendix as table 1. In this regard, the UE may select or determine one or more of a contention window size, a maximum COT length, and/or any other suitable parameter shown in table 1 associated with the smallest UL channel access priority class value (e.g., 1). In some aspects, block 1220 may include selecting one or more channel access parameters based on a smallest DL channel access priority class value. In this regard, the DL channel access priority class values and their relevant parameters are provided in the appendix as table 2. In this regard, the UE may select or determine one or more of a contention window size, a maximum COT length, and/or any other suitable parameter shown in table 2 associated with the smallest DL channel access priority class value (e.g., 1). In another aspect, block 1220 may include selecting one or more channel access parameters based on a smallest PSFCH channel access priority class value. In this regard, exemplary PSFCH channel access priority class values and their relevant parameters are provided in the appendix as table 3. In another aspect, the SL communication may indicate, or be associated with, a channel access priority class. In some aspects, block 1220 may include selecting one or more channel access parameters based on the indicated channel access priority class.

In another aspect, the UE may be scheduled to transmit, immediately following the transmission of a PSFCH in the PSFCH occasion, a second SL communication. For example, the UE may be scheduled to transmit the second SL communication in the slot following the PSFCH occasion. The second SL communication may include a PSCCH communication, a PSSCH communication, a reference signal, and/or a combination thereof. In some aspects, the second SL communication may be associated with a channel access priority class. Accordingly, in some examples, the UE may select the channel access configuration based on the channel access priority class associated with the second SL communication. In some aspects, the UE may perform a type 1 channel access procedure before transmitting the PSFCH communication in the PSFCH occasion (described further below), and may continue with transmitting the second SL communication after the PSFCH communication without performing additional channel sensing and/or without performing an additional channel access procedure for the second SL communication. In some aspects, the UE may transmit the second SL communication with a cyclic prefix extension to at least partially fill at least one gap symbol between the PSFCH occasion and the beginning of the second SL communication. In some aspects, the UE may transmit the second SL communication without performing an additional channel access procedure if a channel access priority class value associated with the PSFCH communication is equal to or smaller than a channel access priority class value associated with the second SL communication.

In another aspect, block 1220 may include the UE selecting the channel access procedure based on a PSFCH configuration. In some aspects, the method 1200 may include the UE receiving an information element, control element, and/or any other suitable configuration including or indicating the PSFCH configuration. The PSFCH configuration may include or indicate the time and/or frequency resources for PSFCH occasions. In some aspects, the PSFCH configuration may include or indicate at least one of a PSFCH periodicity, a total duration of PSFCH transmissions within an observation period, a number of PSFCH transmissions within an observation period, a duration of each PSFCH occasion or communication, and/or any other suitable parameter. In some aspects, the parameters indicated above may be indicated for or associated with a SCS. For example, a PSFCH configuration for a SCS of 15 kHz and a PSFCH periodicity of 1 may indicate 50 PSFCH transmissions within a 50 ms observation period. The PSFCH configuration for a SCS of 30 kHz and a PSFCH periodicity of 1 may indicate 100 PSFCH transmissions within the 50 ms observation period. In some aspects, block 1220 may include the UE selecting the channel access configuration based on the PSFCH configuration. In some aspects, the UE may select the channel access configuration based on one or more of the PSFCH parameters stated above, including the PSFCH periodicity, the total duration of PSFCH transmissions within the observation period, the number of PSFCH transmissions within the observation period, the duration of each PSFCH occasion or communication, and/or any other suitable parameter.

In some aspects, block 1220 may include the UE selecting a channel access configuration with no channel sensing based on the PSFCH configuration. For example, the UE may select a type 2C channel access configuration, or a no-sensing channel access configuration, based on the configured PSFCH periodicity being at or above a configured threshold. In some aspects, the UE may select the type 2C channel access configuration based on one or more short control signaling conditions, thresholds, or other parameters being satisfied. In some aspects, the UE may select type 2C channel access if the PSFCH periodicity is 4 or higher. In another aspect, the UE may select the type 2C channel access based on the number of PSFCH transmissions within the observation period satisfying a threshold. In other aspects, the UE may select the type 2C channel access based on the total duration of PSFCH transmissions within the observation period satisfying a threshold. For example, the UE may select, for FR1, the type 2C channel access based on the number of PSFCH transmissions within the observation period being equal to or less than 50 and/or the total duration of PSFCH transmissions in the observation period being less than 2.5 ms. In another example, the UE may select, for FR2, the type 2C channel access based on the total duration of PSFCH transmissions in the observation period being less than 10 ms.

In some aspects, the UE may select type 2C channel access for one or more PSFCH occasions within an observation period based on the PSFCH configuration, but may select type 1, type 2A, or type 2B channel access for one or more other PSFCH occasions during the observation period. For example, the method 1200 may include selecting a type 2C channel access procedure for the PSFCH occasion, and selecting a type 1 channel access procedure, a type 2A channel access procedure, or a type 2B channel access procedure for a second PSFCH occasion different from the PSFCH occasion. In some aspects, the UE may be configured to determine or identify a first portion of the observation period in which type 2C channel access is selected, and a second portion in which a different type of channel access is selected. For example, the first portion of the observation period may be determined or identified based on the PSFCH occasions or communications satisfying one or more short control signaling conditions in the first portion. The UE may select type 1, type 2A, or type 2B channel access for the PSFCH occasions in the remaining second portion of the observation period. Table 4 in the Appendix shows durations and other parameters of an observation window in FR1 for which no sensing (e.g., type 2C channel access) may be used. As shown in table 4, the UE may select either a first portion or a second (last) portion of the observation period for no sensing (type 2C channel access) or for other channel access types.

In another aspect, the PSFCH configuration may indicate a partial automatic gain control (AGC) symbol for one or more PSFCH occasions in an observation window. In some aspects, the PSFCH configuration may indicate partial AGC symbols for every PSFCH occasion in the observation period. In other aspects, the PSFCH configuration may indicate a partial AGC symbol for only a portion of the observation period. In some aspects, by In this regard, table 5 in the Appendix shows that other periodicities other than 4 may qualify for no-sensing channel access (e.g., type 2C channel access) if partial AGC symbols are used for PSFCH transmission. In this regard, the PSFCH configuration may indicate the UE to use type 2C channel access for PSFCH periodicities of 4 or 2 for SCS values of 15 kHz and 30 kHz if partial AGC symbols are used. In another aspect, the PSFCH configuration may indicate the UE to use type 2C channel access for a first portion of the observation period and a different type of channel access procedure with sensing (e.g., type 1, type 2A) for a second portion of the observation period. In this regard, the use of partial AGC symbols may increase the duration of the portion of the observation period for which type 2C channel access may be used. In some aspects, the PSFCH configuration may indicate the UE to use ⅔ of a OFDM symbol for AGC with one or more PSFCH transmissions. In other aspects, the PSFCH configuration may indicate the UE to use ½ of a OFDM symbol for AGC with one or more PSFCH transmissions. The PSFCH configuration may indicate the UE to use partial AGC symbols for all PSFCH occasions during an observation period, or for only a portion of the observation period.

At block 1230, the UE transmits, based on the channel access configuration selected at block 1220 and the SL communication received at block 1210, a PSFCH communication in the PSFCH occasion in the shared frequency band. In some aspects, the method 1200 further comprises performing a channel access procedure based on the channel access configuration selected at block 1220. In some aspects, the channel access procedure may include or involve channel sensing. In other aspects, the channel access procedure may include or involve no channel sensing (e.g., type 2C channel access). In some aspects, block 1230 may include the UE transmitting the PSFCH communication based on type 1 channel access parameters selected based on at least one of a lowest UL CAPC value, a lowest DL CAPC value, or a lowest PSFCH CAPC value, as explained above.

In some aspects, the method 1200 further includes the UE transmitting a second SL communication after transmitting the PSFCH communication. In some aspects, the UE may transmit the second SL communication after transmitting the PSFCH communication without performing additional channel sensing. For example, the UE may perform a type 1 channel access procedure before transmitting the PSFCH communication, and may transmit the second SL communication based on the type 1 channel access procedure performed for the PSFCH communication. In some aspects, transmitting the second SL communication may include transmitting the second SL communication with a cyclic prefix (CP) extension in at least one gap symbol between the PSFCH communication and the second SL communication. In some aspects, transmitting the second SL communication may be based on at least one of a first CAPC value for the PSFCH communication and a second CAPC value for the second SL communication. In some aspects, the UE may transmit the second SL communication without additional sensing if the first CAPC value for the PSFCH communication is larger than the second CAPC value for the second SL communication.

In some aspects, transmitting the PSFCH communication may include transmitting the PSFCH communication using a partial AGC symbol preceding a PSFCH symbol. In some aspects, transmitting the PSFCH communication may include transmitting ⅔ of an AGC symbol, ½ of an AGC symbol, or any other suitable portion of an AGC symbol with the PSFCH symbol. In other aspects, transmitting the PSFCH communication may include transmitting a full AGC symbol with the PSFCH symbol. In some aspects, the UE may transmit the PSFCH communication with no channel sensing based on one or more short control signaling configurations or parameters, as explained above.

### Exemplary Aspects of the Disclosure

Aspect 1. A method of wireless communication performed in a shared frequency band at a user equipment (UE), the method comprising: receiving a sidelink (SL) communication; selecting a channel access configuration for a physical sidelink feedback channel (PSFCH) occasion in a shared frequency band; and transmitting, based on the channel access configuration and the SL communication, a PSFCH communication in the PSFCH occasion in the shared frequency band.

Aspect 2. The method of aspect 1, wherein the receiving the SL communication comprises receiving the SL communication from a second UE, and wherein the selecting the channel access configuration comprises selecting, based on the PSFCH occasion not being in a shared portion of a channel occupancy time (COT), a type 1 channel access configuration for the PSFCH occasion.

Aspect 3. The method of aspect 2, wherein the selecting the channel access configuration comprises selecting one or more type 1 channel access parameters based on a smallest uplink (UL) channel access priority class value.

Aspect 4. The method of any of aspects 2-3, wherein the selecting the channel access configuration comprises selecting one or more type 1 channel access parameters based on a smallest downlink (DL) channel access priority class value.

Aspect 5. The method of any of aspects 2-4, wherein the selecting the channel access configuration comprises selecting one or more type 1 channel access parameters based on a smallest PSFCH channel access priority class value.

Aspect 6. The method of any of aspects 2-5, wherein the SL communication indicates a channel access priority class associated with the PSFCH occasion, and wherein the selecting the channel access configuration is based on the indicated channel access priority class.

Aspect 7. The method of any of aspects 2-6, further comprising: transmitting, after the transmitting the PSFCH communication, a second SL communication associated with a channel access priority class, wherein the selecting the channel access configuration is based on the channel access priority class.

Aspect 8. The method of any of aspects 2-7, wherein: The transmitting the PSFCH communication comprises performing channel access sensing based on the type 1 channel access configuration and a first channel access priority class; and wherein the method further comprises: transmitting, after the transmitting the PSFCH communication and based on the channel access sensing, a second SL communication associated with a second channel access priority class, wherein the second channel access priority class value is equal to or smaller than the first channel access priority class value.

Aspect 9. The method of any of aspects 1-8, wherein the selecting the channel access configuration comprises selecting the channel access configuration based on a PSFCH configuration, wherein the PSFCH configuration indicates time resources for the PSFCH occasion.

Aspect 10. The method of aspect 9, wherein the PSFCH configuration indicates a PSFCH occasion periodicity, and wherein the selecting the channel access configuration is based on the PSFCH periodicity.

Aspect 11. The method of aspect 10, wherein the transmitting the PSFCH communication comprises refraining, based on the PSFCH periodicity being at or above a configured threshold, from performing channel access sensing for the PSFCH occasion.

Aspect 12. The method of any of aspects 10-11, wherein: the transmitting the PSFCH communication comprises transmitting the PSFCH communication without performing channel access sensing in a first portion of an observation window, the method further comprises: selecting, based on the PSFCH configuration, a second channel access configuration associated with a second PSFCH occasion, wherein the second PSFCH occasion is in a second portion of the observation window different from the first portion; and transmitting, based on the second channel access configuration, a second PSFCH communication in the second PSFCH occasion; and the selecting the second channel access configuration is based on a number of PSFCH occasions in the first portion of the observation window.

Aspect 13. The method of aspect 12, wherein: the PSFCH configuration indicates a partial automatic gain control (AGC) symbol for PSFCH communication; and the selecting the channel access configuration and the selecting the second channel access configuration is based on the partial AGC symbol.

Aspect 14. A user equipment (UE) comprising: a memory device; a transceiver; and a processor in communication with the memory device and the transceiver, wherein the UE is configured to perform the actions of any of aspects 1-13.

Aspect 15. A non-transitory, computer-readable medium having program instructions recorded thereon, wherein the program instructions are executable by a processor of a user equipment (UE) to cause the UE to perform the actions of any of aspects 1-13.

Aspect 16: A user equipment (UE) comprising means for performing the actions of any of aspects 1-13.

Aspect Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspect illustrated and described herein, as they are merely by way of some examples thereof, but rather, should be fully commensurate with that of the claims appended hereafter and their functional equivalents.

| Channel | | | | | |
|---|---|---|---|---|---|
| Access | | | | | |
| Priority | | | | | Allowed |
| Class (p) | mₚ | CW_{min, p} | CW_{max, p} | T_{ulmcot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter absenceOfAnyOtherTechnology-r14 or absenceOfAnyOtherTechnology-r16 is provided, otherwise, T_{ulmcot, p} = 6 ms.
NOTE 2:
When T_{ulmcot, p} = 6 ms it may be increased to 8 ms by inserting one or more gaps. The minimum duration of a gap shall be 100 us. The maximum duration before including any such gap shall be 6 ms.

TABLE 1
CAPC values and associated channel access parameters for UL

| Channel | | | | | |
|---|---|---|---|---|---|
| Access | | | | | |
| Priority | | | | | Allowed |
| Class (p) | mₚ | CW_{min, p} | CW_{max, p} | T_{ulmcot, p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |

TABLE 2
CAPC values and associated channel access parameters for DL

| Channel | | | | | |
|---|---|---|---|---|---|
| Access | | | | | |
| Priority | | | | | Allowed |
| Class (p) | mₚ | CW_{min, p} | CW_{max, p} | T_{ulmcot, p} | CWₚ sizes |
| 1 | 1 | 2 | 5 | 1 ms | {2, 5} |
| . . . | | | | | |

TABLE 3
CAPC values and associated channel access parameters for PSFCH

| | SCS(kHz) | | | | | | | | |
|---|---|---|---|---|---|---|---|---|---|
| | 15 | | | 30 | | | 60 | | |
| | PSFCH duration (us) | | | | | | | | |
| | 143 | | | 71.5 | | | 35.75 | | |
| | PSFCH periodicity (slot) | | | | | | | | |
| | 1 | 2 | 4 | 1 | 2 | 4 | 1 | 2 | 4 |
| The number of PSFCH | 50 | 2\|5 | 12 | 100 | 50 | 25 | 200 | 100 | 50 |
| transmissions within 50 ms | | | | | | | | | |
| Total duration of PSFCH | 7.15 | 3.575 | 1.7875 | 7.15 | 3.575 | 1.7875 | 7.15 | 3.575 | 1.7875 |
| transmission within 50 ms | | | | | | | | | |
| PSFCH without sensing | First or | First or | 50 ms | First or | First or | 50 ms | First or | First or | 50 ms |
| | last | last | | last | last | | last | last | |
| | 17 ms | 34 ms | | 17 ms | 34 ms | | 12.5 ms | 12.5 ms | |
| PSFCH with type 1 channel | Last or | Last or | NA | Last or | Last or | NA | Last or | Last or | NA |
| access | first | first | | first | first | | first | first | |
| | 33 ms | 16 ms | | 33 ms | 16 ms | | 37.5 ms | 37.5 ms | |

1. A method of wireless communication performed in a shared frequency band at a user equipment (UE), the method comprising:
receiving a sidelink (SL) communication;
selecting a channel access configuration for a physical sidelink feedback channel (PSFCH) occasion in a shared frequency band; and
transmitting, based on the channel access configuration and the SL communication, a PSFCH communication in the PSFCH occasion in the shared frequency band.

2. The method of claim 1, wherein the receiving the SL communication comprises receiving the SL communication from a second UE, and wherein the selecting the channel access configuration comprises selecting, based on the PSFCH occasion not being in a shared portion of a channel occupancy time (COT), a type 1 channel access configuration for the PSFCH occasion.

3. The method of claim 2, wherein the selecting the channel access configuration comprises selecting one or more type 1 channel access parameters based on a smallest uplink (UL) channel access priority class value.

4. The method of claim 2, wherein the selecting the channel access configuration comprises selecting one or more type 1 channel access parameters based on a smallest downlink (DL) channel access priority class value.

5. The method of claim 2, wherein the selecting the channel access configuration comprises selecting one or more type 1 channel access parameters based on a smallest PSFCH channel access priority class value.

6. The method of claim 2, wherein the SL communication indicates a channel access priority class associated with the PSFCH occasion, and wherein the selecting the channel access configuration is based on the indicated channel access priority class.

7. The method of claim 2, further comprising:
transmitting, after the transmitting the PSFCH communication, a second SL communication associated with a channel access priority class,
wherein the selecting the channel access configuration is based on the channel access priority class.

8. The method of claim 2, wherein:
The transmitting the PSFCH communication comprises performing channel access sensing based on the type 1 channel access configuration and a first channel access priority class; and
wherein the method further comprises:
transmitting, after the transmitting the PSFCH communication and based on the channel access sensing, a second SL communication associated with a second channel access priority class, wherein the second channel access priority class value is equal to or smaller than the first channel access priority class value.

9. The method of claim 1, wherein the selecting the channel access configuration comprises selecting the channel access configuration based on a PSFCH configuration, wherein the PSFCH configuration indicates time resources for the PSFCH occasion.

10. The method of claim 9, wherein the PSFCH configuration indicates a PSFCH occasion periodicity, and wherein the selecting the channel access configuration is based on the PSFCH periodicity.

11. The method of claim 10, wherein the transmitting the PSFCH communication comprises refraining, based on the PSFCH periodicity being at or above a configured threshold, from performing channel access sensing for the PSFCH occasion.

12. The method of claim 10, wherein:
the transmitting the PSFCH communication comprises transmitting the PSFCH communication without performing channel access sensing in a first portion of an observation window,
the method further comprises:
selecting, based on the PSFCH configuration, a second channel access configuration associated with a second PSFCH occasion, wherein the second PSFCH occasion is in a second portion of the observation window different from the first portion; and
transmitting, based on the second channel access configuration, a second PSFCH communication in the second PSFCH occasion; and
the selecting the second channel access configuration is based on a number of PSFCH occasions in the first portion of the observation window.

13. The method of claim 12, wherein:
the PSFCH configuration indicates a partial automatic gain control (AGC) symbol for PSFCH communication; and
the selecting the channel access configuration and the selecting the second channel access configuration is based on the partial AGC symbol.

14. The method of claim 10, wherein:
the PSFCH configuration indicates a partial automatic gain control (AGC) symbol for PSFCH communication; and
the selecting the channel access configuration is based on the partial AGC symbol.

15. A user equipment (UE), comprising:
a memory device;
a transceiver; and
a processor in communication with the memory device and the transceiver, wherein the UE is configured to:
receive a sidelink (SL) communication;
select a channel access configuration for a physical sidelink feedback channel (PSFCH) occasion in a shared frequency band; and
transmit, based on the channel access configuration and the SL communication, a PSFCH communication in the PSFCH occasion in the shared frequency band.

16. The UE of claim 15, wherein the UE is configured to receive the SL communication from a second UE, and wherein the UE configured to select the channel access configuration comprises the UE configured to select, based on the PSFCH occasion not being in a shared portion of a channel occupancy time (COT), a type 1 channel access configuration for the PSFCH occasion.

17. The UE of claim 16, wherein the UE configured to select the channel access configuration comprises the UE configured to select one or more type 1 channel access parameters based on a smallest uplink (UL) channel access priority class value.

18. The UE of claim 16, wherein the UE configured to select the channel access configuration comprises the UE configured to select one or more type 1 channel access parameters based on a smallest downlink (DL) channel access priority class value.

19. The UE of claim 16, wherein the UE configured to select the channel access configuration comprises the UE configured to select one or more type 1 channel access parameters based on a smallest PSFCH channel access priority class value.

20. The UE of claim 16, wherein the SL communication indicates a channel access priority class associated with the PSFCH occasion, and wherein the UE is configured to select the channel access configuration based on the indicated channel access priority class.

21. The UE of claim 16, wherein the UE is further configured to:
transmit, after the transmitting the PSFCH communication, a second SL communication associated with a channel access priority class,
wherein the UE is configured to select the channel access configuration based on the channel access priority class.

22. The UE of claim 16, wherein:
the UE configured to transmit the PSFCH communication comprises the UE configured to perform channel access sensing based on the type 1 channel access configuration and a first channel access priority class; and
wherein the UE is further configured to:
transmit, after the transmitting the PSFCH communication and based on the channel access sensing, a second SL communication associated with a second channel access priority class, wherein the second channel access priority class value is equal to or smaller than the first channel access priority class value.

23. The UE of claim 15, wherein the UE configured to select the channel access configuration comprises the UE configured to select the channel access configuration based on a PSFCH configuration, wherein the PSFCH configuration indicates time resources for the PSFCH occasion.

24. The UE of claim 23, wherein the PSFCH configuration indicates a PSFCH occasion periodicity, and wherein the UE is configured to select the channel access configuration based on the PSFCH periodicity.

25. The UE of claim 24, wherein the UE configured to transmit the PSFCH communication comprises the UE configured to refrain, based on the PSFCH periodicity being at or above a configured threshold, from performing channel access sensing for the PSFCH occasion.

26. The UE of claim 24, wherein:
the UE is configured to transmit the PSFCH without performing channel access sensing in a first portion of an observation window,
the UE is further configured to:
select, based on the PSFCH configuration, a second channel access configuration associated with a second PSFCH occasion, wherein the second PSFCH occasion is in a second portion of the observation window different from the first portion; and
transmit, based on the second channel access configuration, a second PSFCH communication in the second PSFCH occasion; and
the UE is configured to select the second channel access configuration based on a number of PSFCH occasions in the first portion of the observation window.

27. The UE of claim 26, wherein:
the PSFCH configuration indicates a partial automatic gain control (AGC) symbol for PSFCH communication; and
the UE is configured to select the channel access configuration and the second channel access configuration based on the partial AGC symbol.

28. The UE of claim 24, wherein:
the PSFCH configuration indicates a partial automatic gain control (AGC) symbol for PSFCH communication; and
the UE is configured to select the channel access configuration based on the partial AGC symbol.

29. A non-transitory, computer-readable medium having program code recorded thereon, wherein the program code comprises instructions executable by a processor of a user equipment (UE) to cause the UE to:
receive a sidelink (SL) communication;
select a channel access configuration for a physical sidelink feedback channel (PSFCH) occasion in a shared frequency band; and
transmit, based on the channel access configuration and the SL communication, a PSFCH communication in the PSFCH occasion in the shared frequency band.

30. A user equipment (UE), comprising:
means for receiving a sidelink (SL) communication;
means for selecting a channel access configuration for a physical sidelink feedback channel (PSFCH) occasion in a shared frequency band; and
means for transmitting, based on the channel access configuration and the SL communication, a PSFCH communication in the PSFCH occasion in the shared frequency band
